(19) United States
(12) Patent Application Publication
(10) Pub. No.: US 2025/0069466 A1
(43) Pub. Date: Feb. 27, 2025

(54) GUI FOR SLOT MACHINE GAME WITH TRIGGER SYMBOLS THAT CAN POTENTIALLY TRIGGER FEATURE GAME OR PROVIDE MULTIPLIER EFFECT IN BASE GAME

(71) Applicant: Aristocrat Technologies, Inc., Las Vegas, NV (US)

(72) Inventor: Jeffrey Uss, Liberty Hill, TX (US)

(21) Appl. No.: 18/455,512

(22) Filed: Aug. 24, 2023

(51) Int. Cl. G07F 17/32

(52) U.S. Cl. CPC G07F 17/3213; G07F 17/3223; G07F 17/3267

(57) ABSTRACT

A graphical user interface for providing a game of chance with metamorphic indicators is provided. The metamorphic indicators may each be associated with a different benefit. Whenever a trigger symbol corresponding to one of the metamorphic indicators is displayed in a base game outcome, the GUI may be caused to transition to one of several possible states—a state in which a first feature is enabled and a second feature is not enabled, a state in which the first feature is not enabled and the second feature is enabled, and a state in which neither the first feature nor the second feature is enabled.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

In some games of chance, e.g., slot-type games, there may be certain symbols that, when displayed (or when at least a certain number of them are displayed) as part of a game outcome cause awards specific to each such symbol to be awarded to the player. Such symbols are typically referred to as “cash-on-reel” symbols.

### SUMMARY

Disclosed herein are slot machine games that have metamorphic indicators that are “fed” by the appearance of one or more corresponding symbols in a base game outcome. A metamorphic indicator is, for the purposes of this disclosure, a graphical indicator that generally remains visible on-screen during base game play and which is associated with an ordered sequence of graphical states. During game play, a metamorphic indicator may occasionally be caused to progress from one graphical state to the next in response to the inclusion of at least one corresponding symbol for the metamorphic indicator in a base game outcome. Each metamorphic indicator is associated with a corresponding benefit or enhancement, and the various graphical states for a given metamorphic indicator are generally selected so as to convey to the viewer that the benefit associated with that metamorphic indicator is likely becoming more beneficial or more likely to be provided. For example, the various graphical states for a given metamorphic indicator may, in some cases, consist of a series of progressively larger graphical representations of the object represented by the metamorphic indicator (such as a money bag that grows in size with each change in graphical state, thereby conveying that a) the money bag has more money in it and b) that the money bag is more likely to burst due to being overfilled). In other instances, the various graphical states for a metamorphic indicator may represent different stages of growth or evolution of an object, e.g., a flower or tree may be shown as growing larger with each change in graphical state. In yet other instances, the size of the metamorphic indicator may remain unchanged in the various graphical states associated therewith, but there may be a glow, halo, fiery outline, etc., around the object depicted by the metamorphic indicator that may grow in size and/or intensity with each change in graphical state. In yet another example, the graphical states may each represent an animation of the metamorphic indicator. For example, an object that serves as the metamorphic indicator may be caused to move so as to appear to vibrate and the speed of vibration may be caused to increase with each change in graphical state.

Each time at least one symbol corresponding to a given metamorphic indicator is displayed in a base game outcome, the GUI may be caused to transition to one of at least three possible follow-on states. The particular state that the GUI transitions to may be selected randomly, although the various states may have different weightings or probabilities with regard to how often each is randomly selected. A first state that the GUI may be transitioned to is one in which a first feature is activated but a second feature is not activated. The first feature, for example, may be a feature game, such as a hold-and-spin or free-spins game, that is separate from the base game and the second feature, for example, may be a multiplier feature in which one or more multipliers are applied to any potential winning patterns that may exist in the base game outcome that resulted in the GUI state transition. A second state that the GUI may be transitioned to is one in which the first feature is not activated but the second feature is activated. A third state that the GUI may be transitioned to is one in which neither the first feature nor the second feature is activated.

In a typical game with metamorphic indicators, the symbols that correspond with each metamorphic indicator (and that may trigger a transition in graphical state for the metamorphic indicator) may, on display in a base game outcome, potentially cause a change in graphical state for the metamorphic indicator and may also potentially trigger a feature, such as a feature game. The change in graphical state of the metamorphic indicator, while generally representing an increase in the benefit associated with the metamorphic indicator and/or an increase in the likelihood that the benefit associated with the metamorphic indicator will be provided, does not, itself, necessarily cause the benefit to be provided. In other words, the changes in graphical state may convey to the user a heightened benefit associated with the corresponding metamorphic indicator, or a heightened probability of the associated benefit being provided, but a change in graphical state is not necessarily tied to actually providing the benefit. Thus, it is possible for a change in graphical state for a metamorphic indicator to occur without the benefit associated with that metamorphic indicator being provided, the benefit associated with the metamorphic indicator to be provided without a change in graphical state of the metamorphic indicator, and for the benefit to be provided in conjunction with a change in graphical state for the metamorphic indicator. Thus, there is generally only one benefit or set of benefits that may potentially be provided to a player in association with the display of at least one symbol that corresponds with a given metamorphic indicator. Moreover, the probability that the benefit(s) associated with a metamorphic indicator will be provided in response to the display of the symbol corresponding to the metamorphic indicator being displayed in a base game may be relatively low, e.g., on the order of 5%, and it may thus be a common occurrence that such symbols are displayed, and the metamorphic indicator's graphical state potentially changed, without the benefit associated with the graphical indicator being provided. This can be disappointing to people engaged with playing the base game.

The present GUIs address this issue by including at least one additional benefit for a metamorphic indicator that may potentially be provided instead of the “main” benefit associated therewith when a corresponding symbol for that metamorphic indicator is included in a base game outcome. The additional benefit may not be as valuable as the main benefit but may nonetheless provide satisfaction to the user and help counter potential dissatisfaction that may arise in the user due to a potential low frequency of the “main” benefit triggering.

Various example GUIs employing such a game mechanism are disclosed herein, but it will be understood that at least the following implementations, in addition to other implementations evident from this disclosure, are considered within the scope of this application.

In some implementations, an electronic gaming machine is provided that includes one or more displays, one or more processors, and one or more memory devices. The one or more memory devices may store computer-executable instructions which, when executed by the one or more processors, cause the one or more processors to: cause a base game graphical user interface (GUI) to be displayed on the one or more displays, the base game GUI including an array of symbol positions and one or more metamorphic indicators associated with a base game; cause, for each play of the base game, a selection of symbols to be displayed in the symbol positions; cause, for each symbol position in which the symbol displayed therein is a trigger symbol associated with one of the one or more metamorphic indicators, a corresponding collection event associated with that symbol position to occur; cause, for each collection event, display of a collection animation involving the trigger symbol displayed in the corresponding symbol position of that collection event and the metamorphic indicator associated with the trigger symbol displayed in the corresponding symbol position of that collection event; randomly determine, for each play of the base game in which one or more collection events occurred, whether to a) enable a first feature and not enable a second feature, b) enable the second feature and not enable the first feature, or c) not enable the first feature nor the second feature; cause, for each play of the base game in which one or more collection events occurred in association with a determination that a) the first feature is to be enabled and the second feature is to not be enabled, a GUI to be presented in which the first feature is enabled and the second feature is not enabled; cause, for each play of the base game in which one or more collection events occurred in association with a determination that b) the second feature is to be enabled and the first feature is to not be enabled, the second feature to be enabled without the first feature being enabled; and cause, for each play of the base game in which one or more collection events occurred in association with a determination that c) neither the first feature nor the second feature is to be enabled, the first feature and the second feature to not be enabled.

In some implementations of the electronic gaming machine, the trigger symbols may be wild symbols that are treated as one or more other symbols when determining winning symbol patterns.

In some implementations of the electronic gaming machine, each metamorphic indicator may be associated with a corresponding feature game enhancement, and the one or more memory devices may store further computer-executable instructions which, when executed by the one or more processors, cause the one or more processors to, for each play of the base game that results in the first feature being enabled, cause a GUI for the feature game to be provided that includes the feature game enhancement(s) in a set of one or more feature game enhancements selected from the feature game enhancement(s) associated with the metamorphic indicator(s) that were involved in any collection animation resulting from that play of the base game.

In some such implementations of the electronic gaming machine, the feature game may be a free-spins game in which a predetermined number of feature game plays is provided for a user and each feature game play in the free-spins game requires no wager.

In some such implementations of the electronic gaming machine, the feature game may include an array of symbol positions, and the feature game enhancements may include at least one of a first feature game enhancement in which the array of symbol positions includes additional symbol positions that are not present when the first feature game enhancement is not included, a second feature game enhancement in which symbol sets from which symbols are selected for display in the symbol positions responsive to each play of the feature game have a reduced number of symbols as compared with the symbol sets when the second feature game enhancement is not included, and a third feature game enhancement in which one or more additional feature game plays is provided for the user in addition to the predetermined number of feature game plays.

In some implementations of the electronic gaming machine, the second feature may be a multiplier feature that, when enabled, causes one or more of the displayed trigger symbols to display a corresponding multiplier value and causes a value associated with any winning pattern of displayed symbols that includes at least one trigger symbol that displays a corresponding multiplier value to be multiplied, before being added to a credit meter presented on the one or more displays, by the displayed multiplier value for each trigger symbol in the winning pattern that displays a corresponding multiplier value.

In some such implementations of the electronic gaming machine, the one or more memory devices may store further computer-executable instructions which, when executed by the one or more processors, cause the one or more processors to determine, for each collection event, whether the metamorphic indicator associated with the trigger symbol displayed in the corresponding symbol position of that collection event, is to undergo a graphical state change and cause, for each instance in which a determination is made that a metamorphic indicator is to undergo a graphical state change, that metamorphic indicator to undergo a graphical state change.

In some implementations, one or more non-transitory, computer-readable media may be provided that store computer-executable instructions which, when executed by one or more processors, cause the one or more processors to: cause a base game graphical user interface (GUI) to be displayed on one or more displays, the base game GUI including an array of symbol positions and one or more metamorphic indicators associated with a base game; cause, for each play of the base game, a selection of symbols to be displayed in the symbol positions; cause, for each symbol position in which the symbol displayed therein is a trigger symbol associated with one of the one or more metamorphic indicators, a corresponding collection event associated with that symbol position to occur; cause, for each collection event, display of a collection animation involving the trigger symbol displayed in the corresponding symbol position of that collection event and the metamorphic indicator associated with the trigger symbol displayed in the corresponding symbol position of that collection event; randomly determine, for each play of the base game in which one or more collection events occurred, whether to a) enable a first feature and not enable a second feature, b) enable the second feature and not enable the first feature, or c) not enable the first feature nor the second feature; cause, for each play of the base game in which one or more collection events occurred in association with a determination that a) the first feature is to be enabled and the second feature is to not be enabled, a GUI to be presented in which the first feature is enabled and the second feature is not enabled; cause, for each play of the base game in which one or more collection events occurred in association with a determination that b) the second feature is to be enabled and the first feature is to not be enabled, the second feature to be enabled without the first feature being enabled; and cause, for each play of the base game in which one or more collection events occurred in association with a determination that c) neither the first feature nor the second feature is to be enabled, the first feature and the second feature to not be enabled.

In some implementations, the trigger symbols may be wild symbols that are treated as one or more other symbols when determining winning symbol patterns.

In some such implementations, each metamorphic indicator may be associated with a corresponding feature game enhancement and the one or more non-transitory, computer-readable media may store further computer-executable instructions which, when executed by the one or more processors, cause the one or more processors to, for each play of the base game that results in the first feature being enabled, cause a GUI for the feature game to be provided that includes the feature game enhancement(s) in a set of one or more feature game enhancements selected from the feature game enhancement(s) associated with the metamorphic indicator(s) that were involved in any collection animation resulting from that play of the base game.

In some such implementations, the feature game may be a free-spins game in which a predetermined number of feature game plays is provided for a user and each feature game play in the free-spins game requires no wager.

In some such implementations, the feature game may include an array of symbol positions, and the feature game enhancements may include at least one of a first feature game enhancement in which the array of symbol positions includes additional symbol positions that are not present when the first feature game enhancement is not included, a second feature game enhancement in which symbol sets from which symbols are selected for display in the symbol positions responsive to each play of the feature game have a reduced number of symbols as compared with the symbol sets when the second feature game enhancement is not included, and a third feature game enhancement in which one or more additional feature game plays is provided for the user in addition to the predetermined number of feature game plays.

In some implementations, the second feature may be a multiplier feature that, when enabled, causes one or more of the displayed trigger symbols to display a corresponding multiplier value and causes a value associated with any winning pattern of displayed symbols that includes at least one trigger symbol that displays a corresponding multiplier value to be multiplied, before being added to a credit meter presented on the one or more displays, by the displayed multiplier value for each trigger symbol in the winning pattern that displays a corresponding multiplier value.

In some implementations, the one or more non-transitory, computer-readable media may store further computer-executable instructions which, when executed by the one or more processors, cause the one or more processors to determine, for each collection event, whether the metamorphic indicator associated with the trigger symbol displayed in the corresponding symbol position of that collection event, is to undergo a graphical state change, and cause, for each instance in which a determination is made that a metamorphic indicator is to undergo a graphical state change, that metamorphic indicator to undergo a graphical state change.

In some implementations, a method may be provided that includes causing, by one or more processors of a gaming machine, a base game graphical user interface (GUI) to be displayed on one or more displays, the base game GUI including an array of symbol positions and one or more metamorphic indicators associated with a base game; causing, by the one or more processors of a gaming machine and for each play of the base game, a selection of symbols to be displayed in the symbol positions; causing, by the one or more processors of a gaming machine and for each symbol position in which the symbol displayed therein is a trigger symbol associated with one of the one or more metamorphic indicators, a corresponding collection event associated with that symbol position to occur; causing, by the one or more processors of a gaming machine and for each collection event, display of a collection animation involving the trigger symbol displayed in the corresponding symbol position of that collection event and the metamorphic indicator associated with the trigger symbol displayed in the corresponding symbol position of that collection event; randomly determining, by the one or more processors and for a plurality of plays of the base game in which one or more collection events occurred, that a first feature is to be enabled and a second feature is to be not enabled in response to at least one play of the base game, that the first feature is to be not enabled and the second feature is to be enabled in response to at least one other play of the base game, and that neither the first feature nor the second feature is to be enabled in response to at least one more play of the base game; causing, by the one or more processors of a gaming machine and for each play of the base game in which one or more collection events occurred in association with a determination that a) the first feature is to be enabled and the second feature is to not be enabled, a GUI to be presented in which the first feature is enabled and the second feature is not enabled; causing, by the one or more processors of a gaming machine and for each play of the base game in which one or more collection events occurred in association with a determination that b) the second feature is to be enabled and the first feature is to not be enabled, the second feature to be enabled without the first feature being enabled; and causing, by the one or more processors of a gaming machine and for each play of the base game in which one or more collection events occurred in association with a determination that c) neither the first feature nor the second feature is to be enabled, the first feature and the second feature to not be enabled.

In some implementations, the trigger symbols may be wild symbols that are treated as one or more other symbols when determining winning symbol patterns.

In some implementations, each metamorphic indicator may be associated with a corresponding feature game enhancement, and the method may further include causing the one or more processors to, for each play of the base game that results in the first feature being enabled, cause a GUI for the feature game to be provided that includes the feature game enhancement(s) in a set of one or more feature game enhancements selected from the feature game enhancement(s) associated with the metamorphic indicator(s) that were involved in any collection animation resulting from that play of the base game.

In some such implementations, the feature game may be a free-spins game in which a predetermined number of feature game plays is provided for a user and each feature game play in the free-spins game requires no wager.

In some such implementations, the feature game may include an array of symbol positions, and the feature game enhancements may include at least one of a first feature game enhancement in which the array of symbol positions includes additional symbol positions that are not present when the first feature game enhancement is not included, a second feature game enhancement in which symbol sets from which symbols are selected for display in the symbol positions responsive to each play of the feature game have a reduced number of symbols as compared with the symbol sets when the second feature game enhancement is not included, and a third feature game enhancement in which one or more additional feature game plays is provided for the user in addition to the predetermined number of feature game plays.

In some implementations, the second feature may be a multiplier feature with a multiplier that, when enabled, causes one or more of the displayed trigger symbols to display a corresponding multiplier value and causes a value associated with any winning pattern of displayed symbols that includes at least one trigger symbol that displays a corresponding multiplier value to be multiplied, before being added to a credit meter presented on the one or more displays, by the displayed multiplier value for each trigger symbol in the winning pattern that displays a corresponding multiplier value.

### BRIEF DESCRIPTION OF THE DRAWINGS

FIG. 1 is an exemplary diagram showing several EGMs networked with various gaming-related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIGS. 4 through 24 depict a GUI according to the concepts discussed herein in various graphical states.

FIG. 25 depicts an example of metamorphic indicator graphical states.

FIG. 26 depicts another example of metamorphic indicator graphical states.

The Figures are provided for the purpose of providing examples and clarity regarding various aspects of this disclosure and are not intended to be limiting.

### DETAILED DESCRIPTION

The following discussion provides overall context for gaming machines that may be used to implement a feature game mechanic such as is described above and later herein. Following this overview, a more focused discussion of the feature game mechanic concepts discussed above is provided.

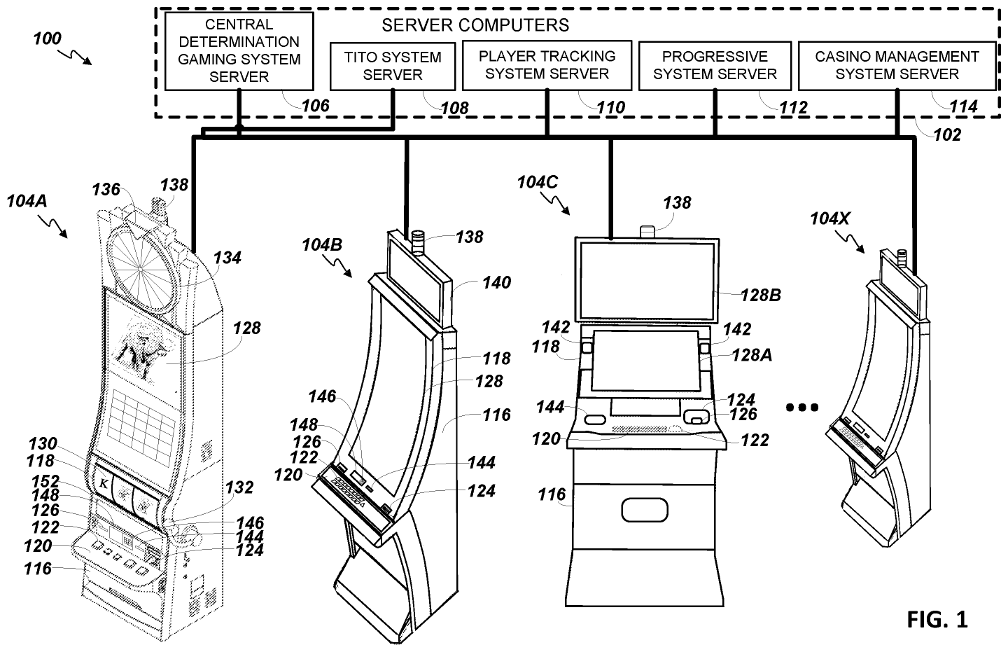

FIG. 1 illustrates several different models of EGMs which may be networked to various gaming-related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

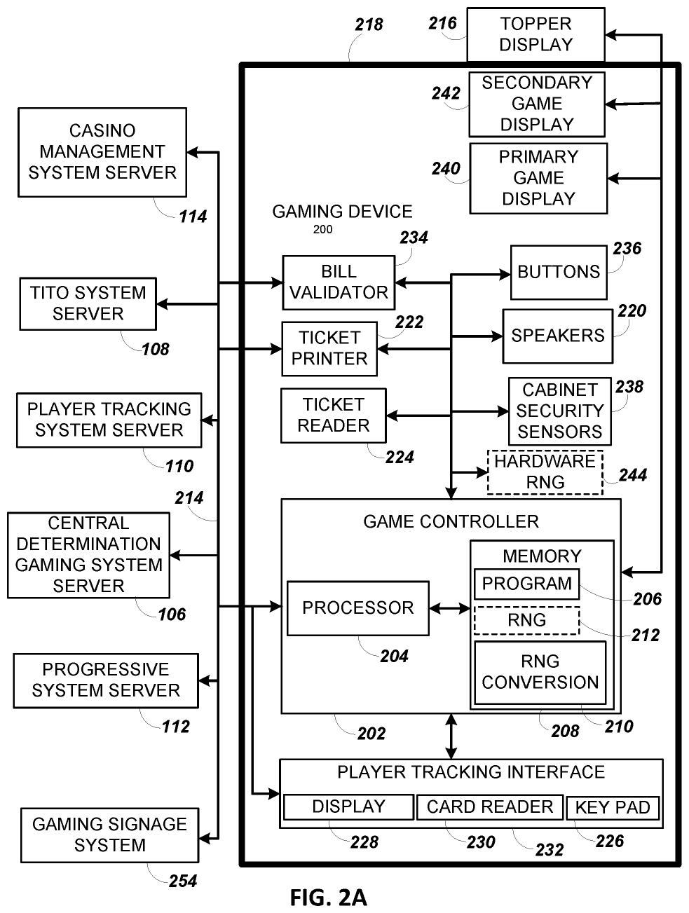

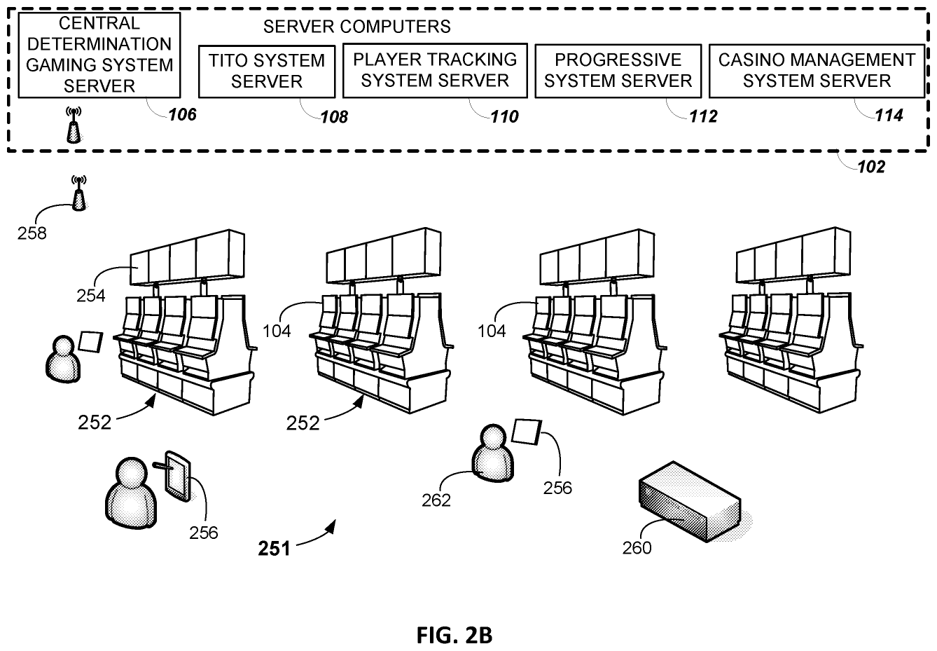

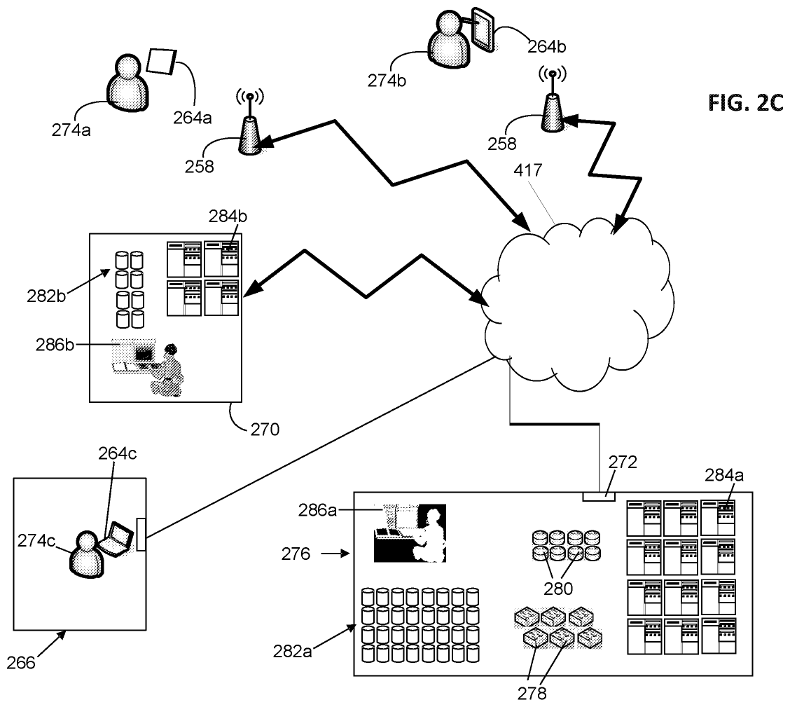

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 may, for example, be a remote gaming server (RGS) or similar system in some implementations. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

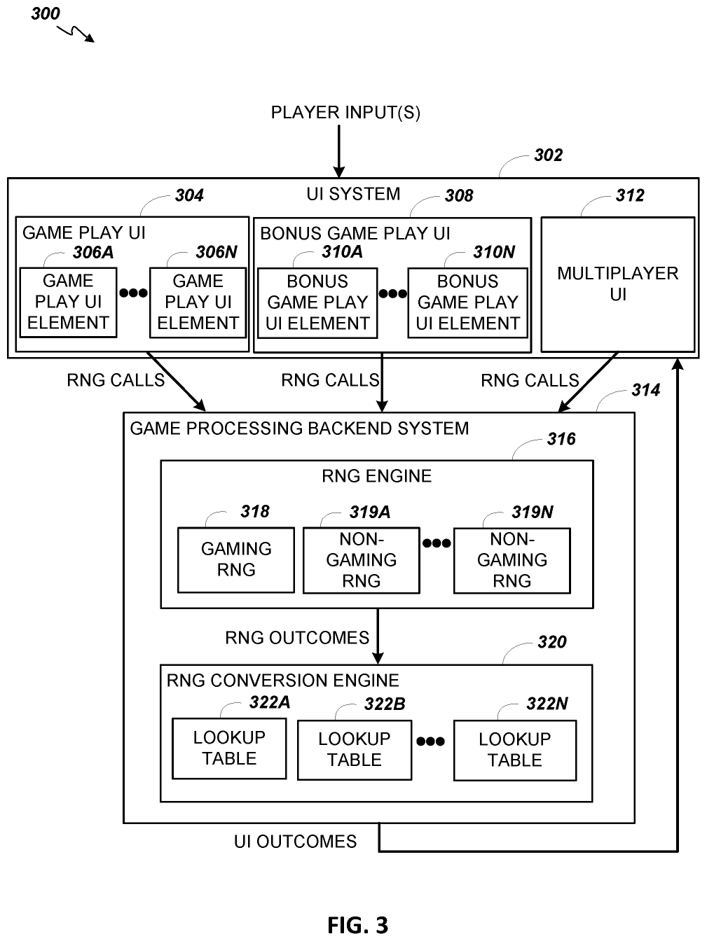

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

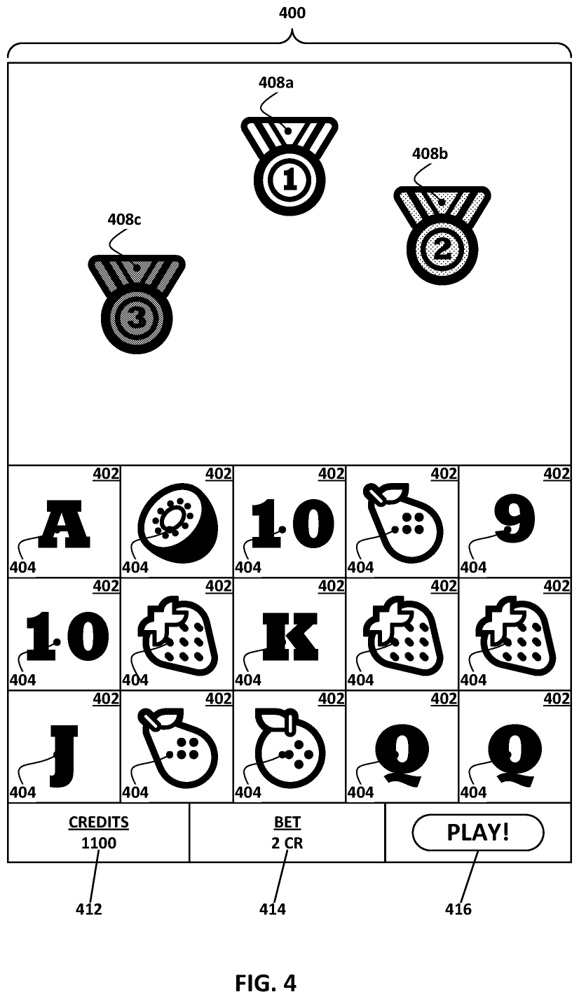

FIGS. 4 through 24, as noted above, depict various states of a graphical user interface (GUI) for game of chance that incorporates metamorphic indicators.

FIG. 4 depicts a base game GUI 400. The base game GUI 400 includes an array of symbol positions 402 in which symbols 404 may be displayed. The array of symbol positions in this example is an array with five columns and three rows of symbol positions 402 (a 5×3 array), but it will be understood that other arrays of symbol positions 402 may be used as well, e.g., a 4×3 array, a 3×3 array, a 6×3 array, a 6×4 array, etc., in other implementations. Additionally, it will be understood that such arrays of symbol positions 402 need not be rectangular arrays, but may also be arrangements of symbol positions 402 in which there may be different numbers of symbol positions in some columns and/or rows than in other columns and/or rows, e.g., an array of symbol positions 402 in which there are five columns of symbol positions 402, with the middle three columns of symbol positions 402 having four rows of symbol positions 402 and the outer two columns of symbol positions 402 having three rows of symbol positions 402.

Generally speaking, each play of the base game using the base game GUI 400 will result in various symbols 404 being selected, e.g., via random selection, being displayed in the symbol positions 402. As in a typical slot machine, patterns of symbols 404 along, for example, paylines that include one symbol position 402 from each column may be evaluated to determine if there are any such patterns that satisfy a win condition. If so, then an amount associated with that win condition may be added to a score or credit meter for the base game. In this example, the symbols include at least “royal” symbols (corresponding to high-value playing card denominations, such as 9, 10, J, Q, K, and A) and fruit symbols. Winning patterns may be formed any time a string of five fruit symbols of the same type is formed along a payline. The example may, for example, be a “ways” game in which there is a payline for each possible combination of symbol positions from all five columns (thus, 35, or 243, paylines) in play for each base game play. In other implementations, however, there may be a more limited number of paylines in play for each base game play. It will also be appreciated that other implementations may utilize other symbols and other types of winning patterns, e.g., winning patterns that do not necessarily require five matching symbols.

Also visible in FIG. 4 are three metamorphic indicators 408a, 408b, and 408c that are displayed in the region above the symbol positions 402. The metamorphic indicators 408a, 408b, and 408c are, in this case, in the form of medals indicating 1^{st}, 2^{nd}, and 3^{rd} place. It will, of course, be understood that a metamorphic indicator 408 may take on any desired form, e.g., medallions, piggy banks, flowers, chests, money bags, etc., depending on the particular theme of the game. It will be noted that the metamorphic indicators 408a, 408b, and 408c have been assigned different shading patterns, with the metamorphic indicator 408a being white in background color, the metamorphic indicator 408b being light grey in background color, and the metamorphic indicator 408c being dark grey in background color. In actual practice, if there are multiple metamorphic indicators 408 that are part of a base game GUI 400, such metamorphic indicators 408 may, for example, be differentiated by representing different articles and/or by using a different color (e.g., red/green/blue/gold/purple/etc.) to represent each metamorphic indicator 408.

The base game GUI 400 may also include a credit meter 412 (or score meter), a bet level indicator 414, and a play button 416. The bet level indicator 414 may, for example, indicate an amount of credits (or points) that will be debited for each play of the base game, which may be initiated by the player by pressing the play button 416 (which may be, for example, a touch-screen control displayed on a touch-sensitive display, as shown, or may be a physical button).

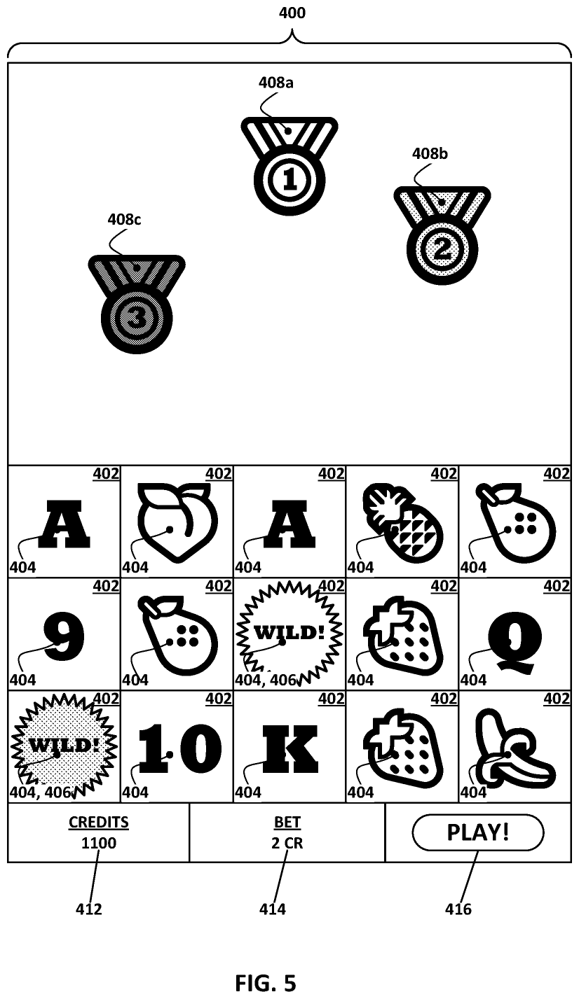

FIG. 5 depicts the base game GUI 400 after a play of the base game has occurred responsive to a touch input received by the play button 416. As can be seen, a new selection of symbols 404 has been made and caused to be displayed in the symbol positions 402 of the base game GUI 400 in order to provide a base game outcome responsive to such touch input. In this particular example base game play, the symbols 404 that are displayed include both royal and fruit symbols, but also include trigger symbols 406. The trigger symbols 406, in this example, are “wild” symbols that may serve as any symbol 404 for the purposes of forming winning patterns of symbols. In other implementations, however, the trigger symbols 406 may not be wild symbols.

Each trigger symbol 406 that is displayed may, for example, correspond with one of the metamorphic indicators 408. For example, the trigger symbols 406 that are used in the example base game GUI 400 of FIGS. 4 through 24 are circles with serrated edges, and each such serrated circle has a fill pattern that matches that of one of the three metamorphic indicators 408a, 408b, or 408c. In FIG. 5, the base game outcome includes one trigger symbol 406 in the middle symbol position 402 that corresponds to the metamorphic indicator 408a (both have a white fill/background) and another trigger symbol 406 in the lower left symbol position 402 that corresponds to the metamorphic indicator 408b (both have a light-gray fill/background).

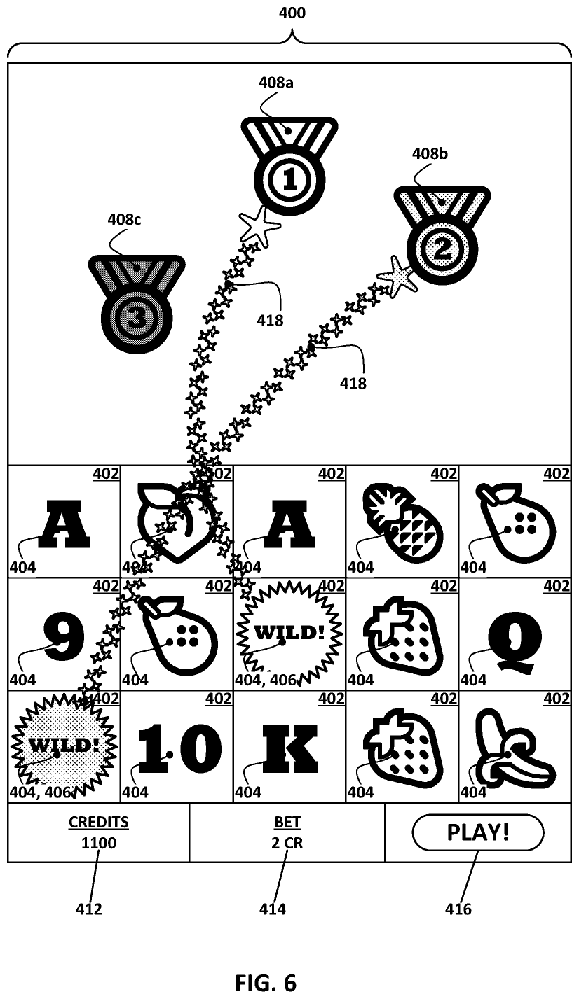

When one or more trigger symbols 406 are shown in a base game outcome, one or more “collection events” may occur in which the displayed trigger symbol(s) 406 may, in some way, be indicated as having a connection or correspondence with the corresponding metamorphic indicator(s). For example, in some implementations, each collection event may include a collection animation 418 in which one or more graphical objects, e.g., particles, are shown moving along or defining a path leading from each trigger symbol 406 to the corresponding metamorphic indicator 408. For example, in FIG. 6, collection animations 418 are shown in which, for each displayed trigger symbol 406, a star, trailing smaller star-like particles behind it, moves along a curving path from that trigger symbol 406 to the corresponding metamorphic indicator 408 for that trigger symbol 406. Thus, for example, one star is shown as traveling along an arcing path from the trigger symbol 406 displayed in the middle symbol position 402 up to the metamorphic indicator 408a, while another star is shown as traveling along another arcing path from the trigger symbol 406 in the lower left corner to the metamorphic indicator 408b. In this example, each collection animation 418 features graphical objects (the star and star trail) that have background shading similar to that of the corresponding trigger symbol 406.

When one or more collection events occur, the processor(s) of the gaming machine presenting the base game GUI may also make a determination as to whether or not to cause the metamorphic indicator 408 involved with any of the one or more collection events to undergo a graphical state change, e.g., changing from one graphical state in a sequence of graphical states to the next graphical state in the sequence, e.g., to grow in size or otherwise alter its appearance. Such a determination may be random or may be according to pre-set thresholds. For example, there may be pre-specified thresholds associated with each graphical state change that a metamorphic indicator 408 may be caused to undergo; whenever the total number of corresponding trigger symbols 406 that have been shown since the metamorphic indicator 408 was last “reset” (or “set”) to the first graphical state in the series of graphical states that the metamorphic indicator 408 can progress through exceeds one of the thresholds, the metamorphic indicator 408 may be caused to transition to the graphical state associated with that threshold. In the event that the determination of whether or not to cause a graphical state change for a metamorphic indicator 408 is a random determination, the probability of such a transition may be set to be different for various graphical states in the sequence of graphical states for a metamorphic indicator 408. For example, it may become progressively less likely for a graphical state change to be triggered as the metamorphic indicator 408 is caused to move through graphical states in the sequence of graphical states. In some implementations, in the event that collection events for multiple metamorphic indicators 408 occur as the result of a single base game play, the determination of whether or not to cause a given one of such metamorphic indicators to undergo a graphical state change may be made separately for each metamorphic indicator.

In addition to determining whether or not any of the metamorphic indicators 408 are to undergo graphical state changes responsive to a corresponding collection event, the processor(s) of the gaming machine may also, responsive to the occurrence of one or more collection events as a result of a base game outcome, make a random determination as to which of a plurality of different enablement states to select for various features. For example, the game in question may include at least a first feature and a second feature, and a random determination may be made in association with the occurrence of one or more collection events as the result of a base game outcome as to whether to enable the first feature without enabling the second feature, enable the second feature without enabling the first feature, or enabling neither the first feature nor the second feature. As noted above, the first feature may be a feature game, such as a hold-and-spin game or a free-spins game, and the second feature may, for example, be a feature that affects base game play, e.g., a multiplier that may be applied to awards associated with winning outcomes contained in the base game outcome that results in the second feature being activated or enabled. The features may also take other forms. For example, the first feature and the second feature may both be feature games, but different types or versions thereof (for example, the first feature may be a hold-and-spin feature game in which obtaining a newly displayed “held” symbol causes the number of feature game plays available to the player to be reset to a default number, while the second feature may be a hold-and-spin feature game in which the player is provided with a set number of plays that cannot be re-set or incremented during the duration of the feature game). In the example of FIGS. 4 through 24, however, the first feature is a “free spins” feature game, and the second feature is a multiplier feature that may multiply amounts associated with winning patterns in the base game outcome that may result in the second feature being provided. These features are explained below in more detail.

If it is determined that the first feature is to be enabled and the second feature not enabled, then the processor(s) of the gaming machine may cause a GUI to be presented in which the first feature is enabled and the second feature is not enabled (e.g., by not even being included in the GUI). Similarly, if it is determined that the second feature is to be enabled and the first feature not enabled, then the processor(s) of the gaming machine may cause a GUI to be presented in which the second feature is enabled and the first feature is not enabled (e.g., by not even being included in the GUI). And if it is determined that neither the first feature nor the second feature is to be enabled, then the processor(s) of the gaming machine may cause a GUI to be presented in which neither the first feature nor the second feature is enabled (e.g., by not even being included in the GUI).

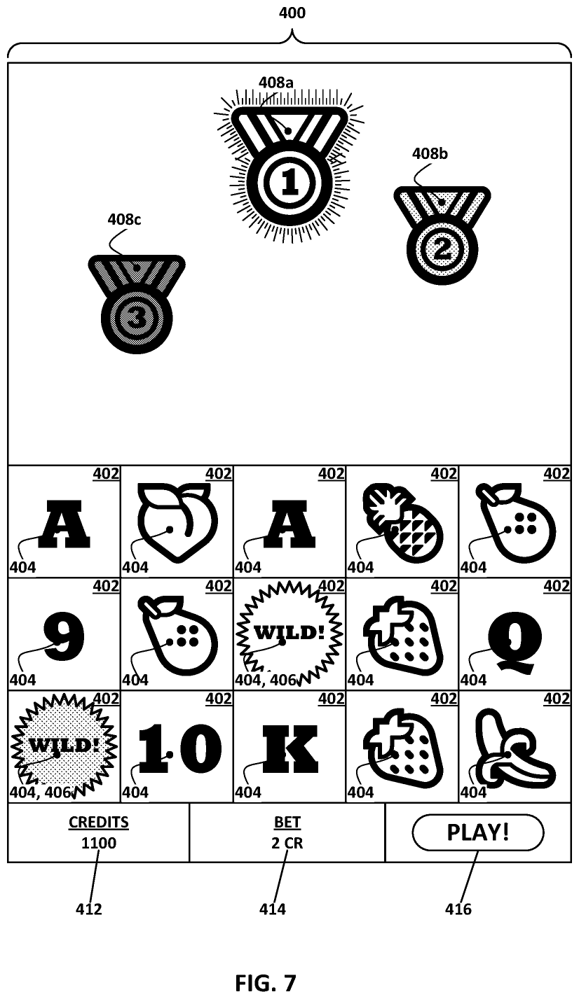

FIG. 7 depicts the base game GUI 400 after the collection animations 418 of FIG. 6 have concluded. As can be seen, the base game GUI 400 has been caused to make the metamorphic indicator 408a undergo a change in graphical state due to a determination, e.g., a random determination, that such a graphical state change should occur in association with the collection event involving the metamorphic indicator 408a. In this case, the metamorphic indicator 408a has been caused to transition to a graphical state in which it is slightly larger than it was prior to the transition. The graphical state change may also be optionally accompanied by one or more animated effects, e.g., such as a sparkling effect in which the perimeter of the metamorphic indicator 408a is outlined in short, radiating lines (as shown). As can be seen, the metamorphic indicator 408b, which was also associated with a collection event resulting from the current base game outcome, did not undergo a graphical state transition since a determination was not made that it should undergo such a transition.

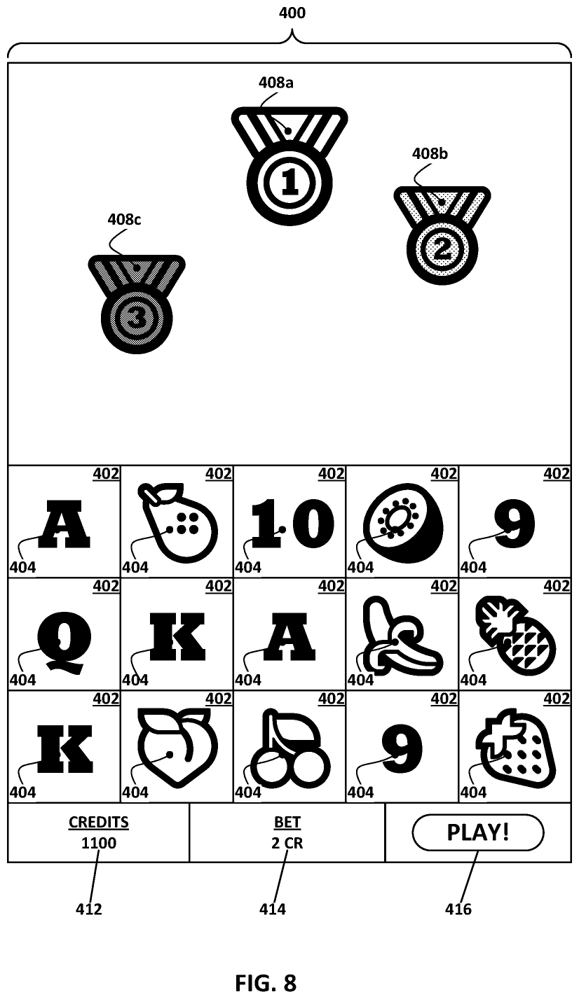

In FIG. 8, a further base game play has occurred, this time with no trigger symbols 406 being displayed. As a result, there are no collection events, and the metamorphic indicators 408 remain as-is.

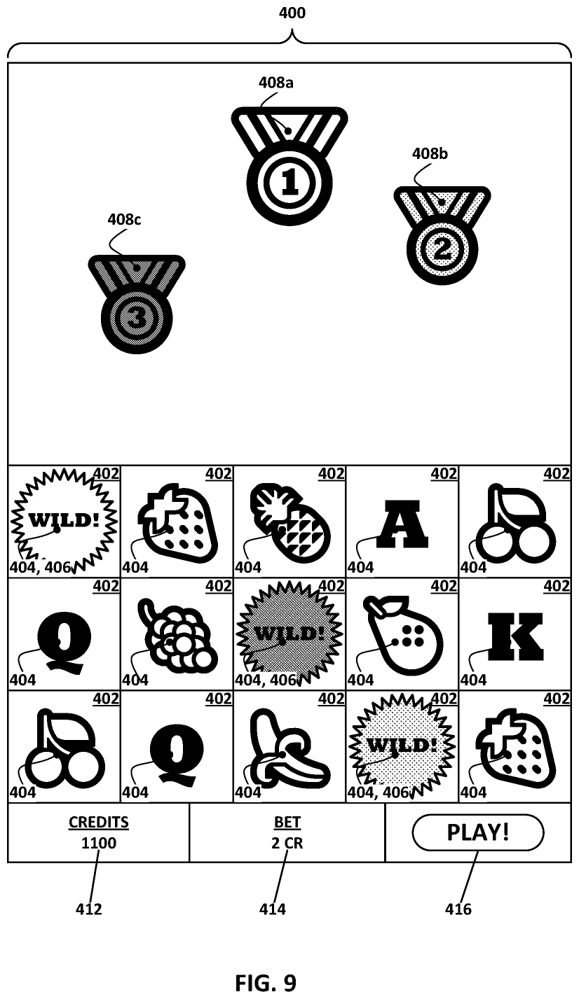

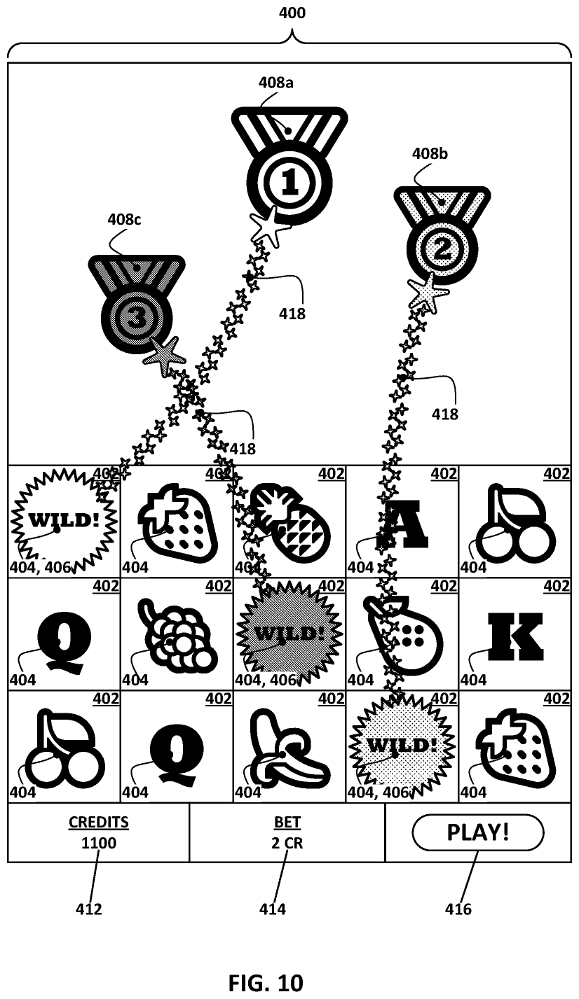

In FIG. 9, another play of the base game has occurred, resulting in a base game outcome in which three trigger symbols 406 have been displayed. In this particular base game outcome, each trigger symbol 406 corresponds with a different one of the metamorphic indicators 408, resulting in three corresponding collection events involving separate collection animations 418, as shown in FIG. 10. In this example base game play, the determinations of whether or not to cause each of the metamorphic indicators 408 to undergo a corresponding graphical state change have resulted in none of the metamorphic indicators 408 being caused to undergo a graphical state change.

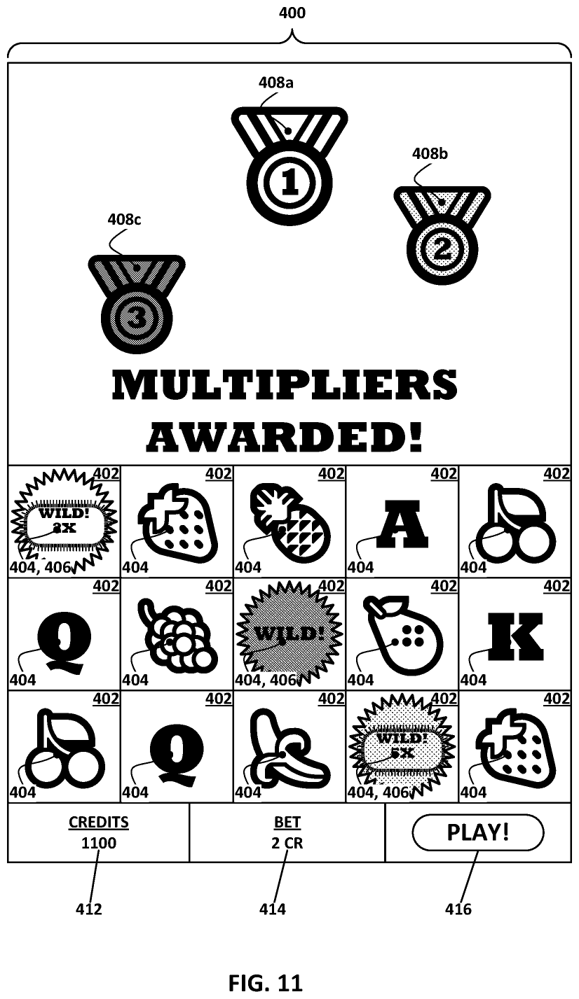

However, since at least one collection event occurred responsive to the base game outcome, a determination is made as to whether to enable the first feature without enabling the second feature, enable the second feature without enabling the first feature, or whether to enable neither the first feature nor the second feature. In this particular instance, the determination has resulted in the second feature being enabled without the first feature being enabled. The base game GUI 400 has thus been caused to display a message communicating that the second feature has been enabled (“Multipliers Awarded!”), as shown in FIG. 11. Additionally, the processor(s) of the gaming machine have caused the base game GUI 400 to be updated to indicate that one or more of the trigger symbols 406 is associated with a corresponding multiplier value. In this example, two of the three trigger symbols 406 have been caused to depict a multiplier value-the trigger symbol 406 in the upper left symbol window 402 has been modified to display a “2×” multiplier value, while the trigger symbol 406 in the bottom symbol position 402 in the fourth column of symbol positions 402 from the left has been modified to display a “5×” multiplier value. The third trigger symbol 406 that is shown in FIG. 11 did not get modified to display a multiplier value.

In this implementation, a random determination is made as to how many of the displayed trigger symbols 406 (or the symbol positions 402 displaying trigger symbols 406) may be caused to be upgraded to display a multiplier value. In other implementations, however, the multiplier upgrade may be applied to any symbol 404 or symbol position 402 shown in the base game GUI 400. In some implementations, the number of symbols 404 or symbol positions 402 that may be caused to be upgraded with a multiplier value may be randomly determined but may be capped at a potential maximum number of such multipliers. For example, in the given implementation, the number of trigger symbols 406 that may be upgraded with multiplier values may be capped so as not to exceed a maximum number of trigger symbols 406 with multipliers assigned. For example, in some implementations-such as the implementation of FIGS. 4 through 24, up to three trigger symbols 406 may be upgraded with multiplier values.

The multiplier value that is selected for association with a given symbol 404 or symbol position 402 may, for example, be selected in a number of ways. In some implementations, one of several predetermined multiplier values may be randomly selected for association with a particular symbol 404 or symbol position 402, e.g., a random selection between 2×, 3×, 5×, 8×, and 10× multiplier values may be made, and the selected multiplier value then assigned to a particular symbol 404 or symbol position 402. Each such multiplier, in some implementations, may have a corresponding weighting that may allow the multipliers to have different probabilities of being randomly selected when determining which multiplier to assign to a given symbol 404 or symbol position 402. In other implementations in which different values of multiplier may be assigned to different symbols 404 or symbol positions 402, the multiplier values may be in a set order or sequence, with each multiplier value being assigned to a corresponding symbol 404 or symbol position 402 in order.

If a feature such as the multiplier feature is enabled or activated, the processor(s) of the gaming machine may cause the award amounts associated with each winning pattern that includes one of the symbols 404, or that passes through one of the symbol positions 402, having a multiplier assigned thereto to be multiplied by that multiplier value. The multiplied award value may then be caused to be added to the credit meter 412.

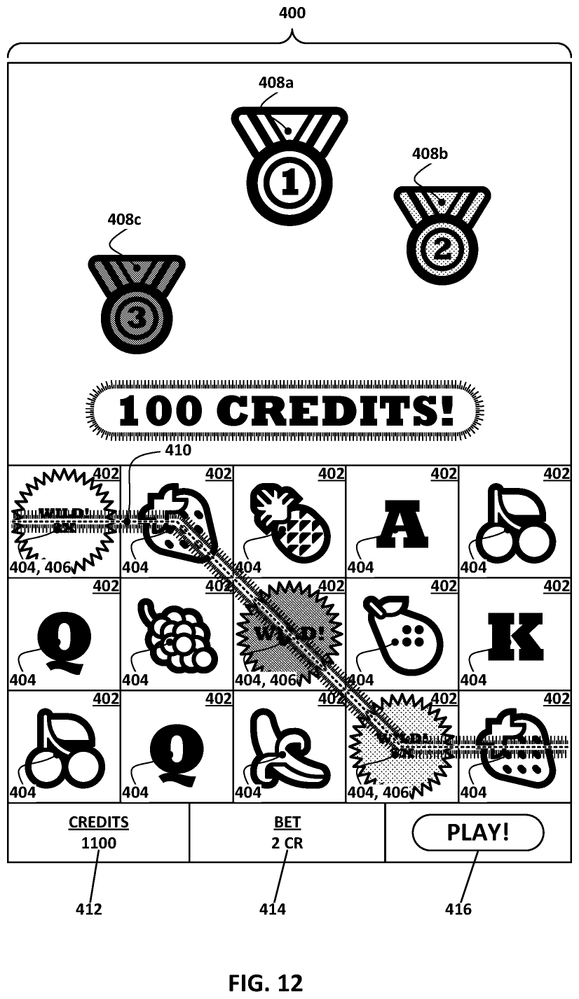

As can be seen in FIG. 12, the base game outcome of FIGS. 9 through 12 results in a winning pattern of symbols 404 being displayed (five strawberry symbols, although three of the five strawberry symbols are provided by way of the trigger symbols 406, which, as discussed above, may act as wild symbols in this implementation and thus serve as equivalents to any symbol) along a payline 410. In this example, obtaining five strawberry symbols results in a corresponding award of 100 credits being provided, as indicated by the base game GUI 400.

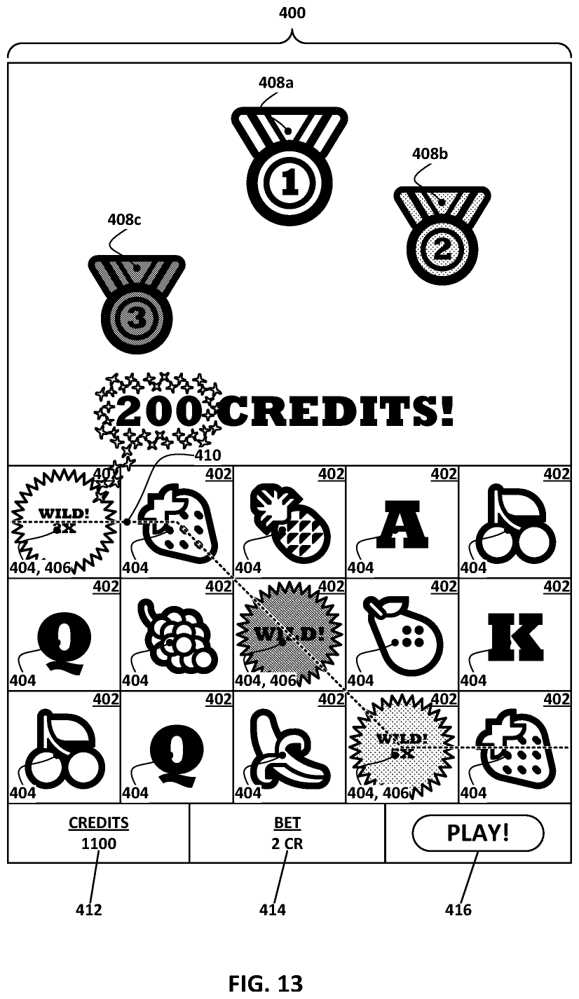

As noted above, the corresponding award of 100 credits may be multiplied by the multiplier or multipliers that apply to the symbol 404 or symbol positions 402 that the payline 410 associated with the award passes through. The application of such a multiplier or multipliers may, for example, be conveyed by the base game GUI 400, in some cases, by way of various animations. For example, as shown in FIG. 13, an animation may be provided in which a stream of particles is caused to flow from each symbol 404 that has a multiplier associated with it (or each symbol position 402 associated with such a multiplier) to the current amount of the award. In this case, a stream of star particles flows from the trigger symbol 406 in the upper left symbol position 402 and towards the award amount of 100, which is then doubled to 200 to reflect that the original award value of 100 credits has been multiplied by 2.

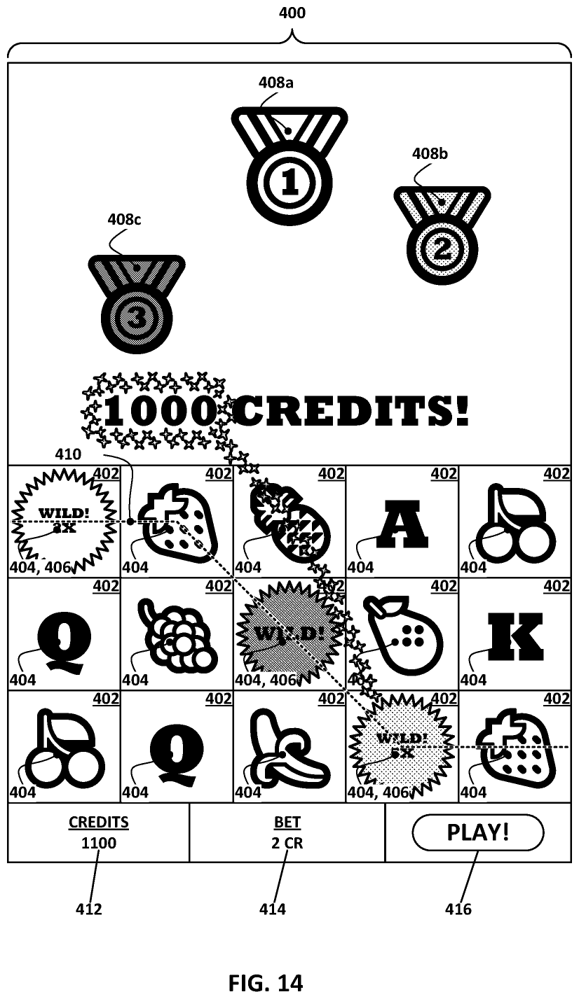

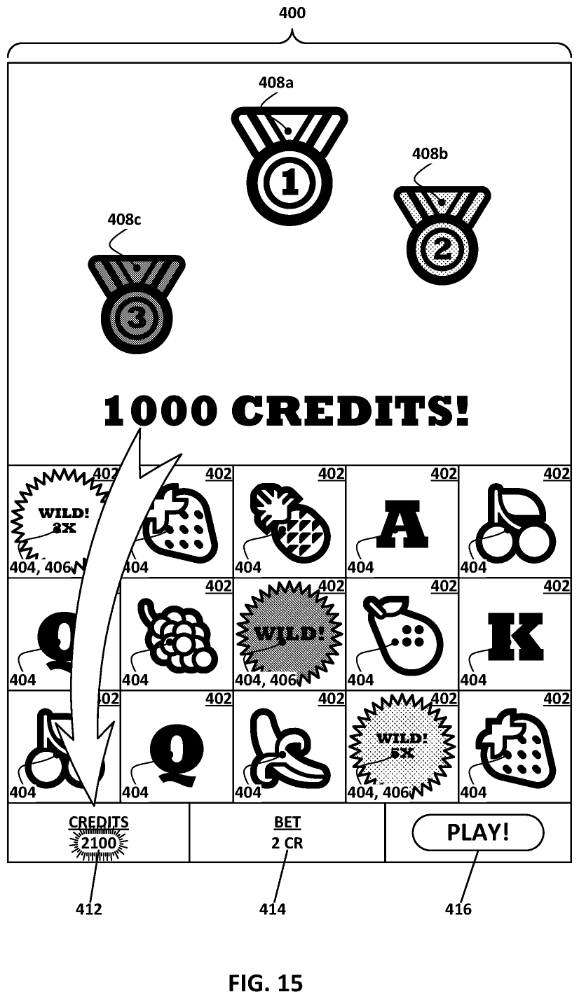

A further animation may be presented in similar fashion to depict the current award value being multiplied by the 5× multiplier, as shown in FIG. 14 (multiplying the 200 credit amount by 5 to result in a 1000 credit current award amount. Once all multipliers have been applied, the final award amount may then be caused to be added to the credit meter 412, as shown in FIG. 15.

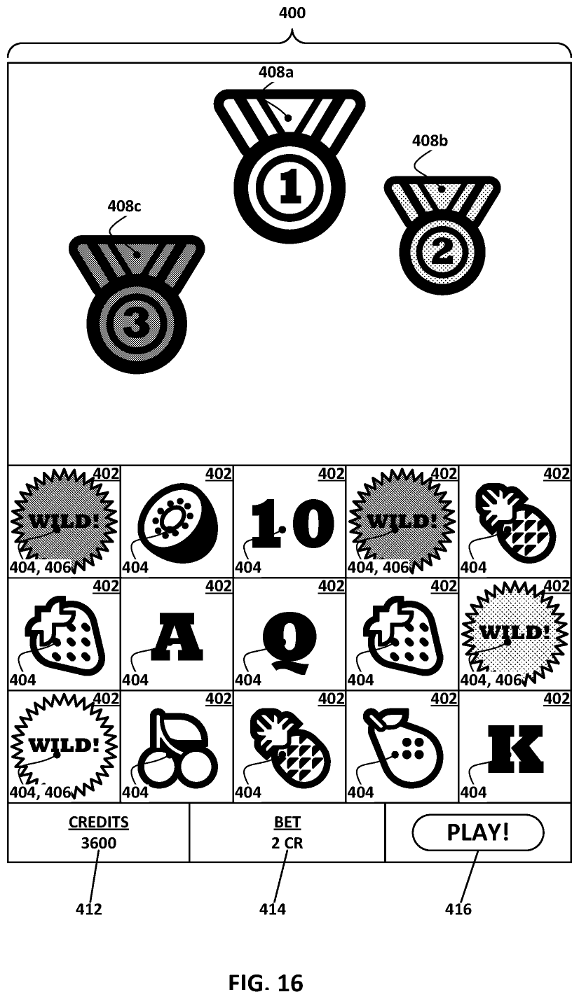

FIG. 16 depicts the base game GUI 400 after several more base game plays have occurred. As can be seen, the credit meter 412 reflects a higher amount than in FIG. 15, indicating that several more awards have been earned through intervening base game outcomes that included winning symbol patterns. It is also apparent that the metamorphic indicators 408a, 408b, and 408c have also undergone graphical state changes (or additional graphical state changes) due to the display of additional trigger symbols 406.

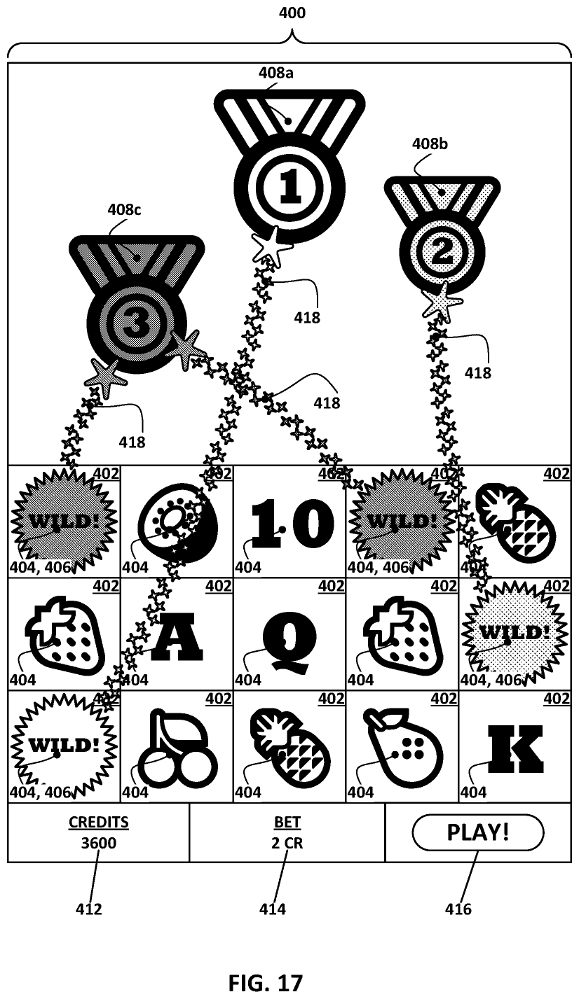

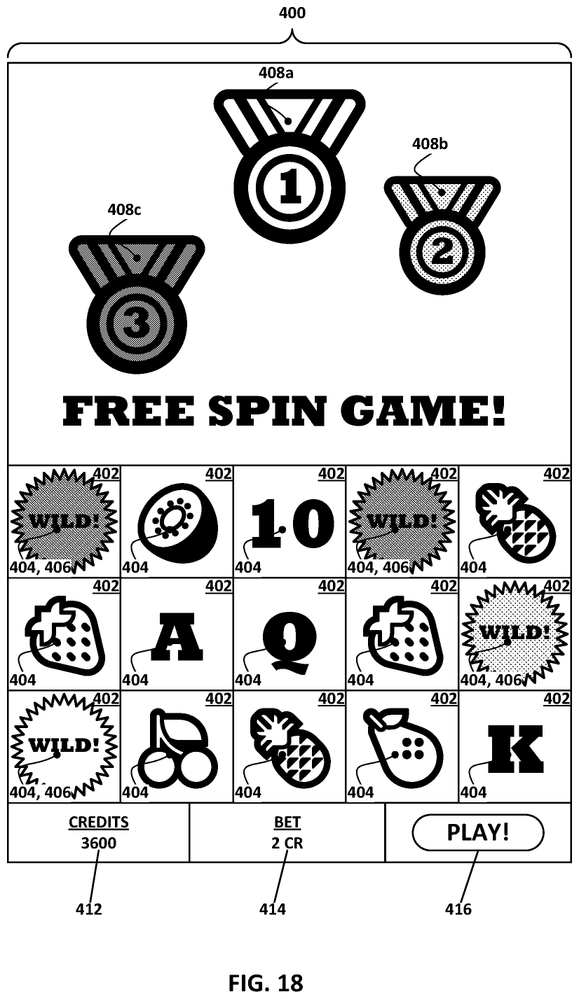

As can be seen in FIG. 16, the most recent base game play has resulted in a base game outcome in which there are four trigger symbols 406 depicted. As a result, four collection events occur, each including a collection animation 418, as shown in FIG. 17. In this instance, the processor(s) of the gaming machine, in response to the collection events occurring, has determined (e.g., based on a random determination) that the first feature is to be enabled without the second feature being enabled. Thus, the multiplier feature discussed above with respect to FIGS. 11 through 15 is not provided in response to these collection events. Instead, a free-spins feature game is provided, as indicated by the base game GUI 400 in FIG. 18. The free-spins feature game may be provided using, for example, the base game GUI 400 or, in other implementations, using a new GUI. In the free-spins feature game, the player may be provided with a number of free plays of the base game (or similar game) in which the player does not need to wager credits for each free play. However, any winning patterns that are obtained as a result of such free plays may still result in the player being provided awards as if such free plays were made with a wager, e.g., a wager equal to the wager that was made in the base game play that resulted in the free spins feature game being provided.

When the feature game is provided in association with one or more collection events occurring, the feature game may be activated with one or more enhancements that are associated with the metamorphic indicators 408 that correspond to the trigger symbols 406 that are displayed in the base game outcome that resulted in the feature game being provided.

For example, for each play of the base game that results in a first feature that is a feature game being enabled, the processor(s) of the gaming machine may cause a GUI for the feature game to be provided that includes the feature game enhancement(s) in a set of one or more feature game enhancements that are selected from the feature game enhancement(s) associated with the metamorphic indicator(s) that were associated with any collection event and/or collection animation resulting from that play of the base game. Such a set may include all of the feature game enhancements that are associated with the metamorphic indicator(s) that are associated with the collection event(s) and/or collection animation(s) resulting from that play of the base game, or may be a subset thereof, e.g., a random selection of one or more such feature game enhancements from the feature game enhancements that are associated with the metamorphic indicator(s) that are associated with the collection event(s) and/or collection animation(s) resulting from that play of the base game.

In the example game of FIGS. 4 through 24, the metamorphic indicator 408a is associated with a feature game enhancement in which all symbols 404 of a certain type, e.g., all royal symbols, are removed from the reels from which symbols 404 are selected for display in the symbol positions 402. Such a feature may improve the chances of obtaining winning symbol patterns, e.g., by removing symbols that cannot contribute to a winning symbol pattern from the potential outcomes that may be generated during the feature game.

Similarly, the metamorphic indicator 408b may be associated with a feature game enhancement in which the size of the array of symbol positions 402 may be caused to increase and/or decrease in size (although not smaller than, for example, the size of the array when the feature game is triggered, and not larger than a designated maximum size) during play of the feature game, thereby potentially increasing the number of symbol positions 402 that are displayed as compared with the number of symbol positions that are displayed during base game play or in feature game play when such a feature enhancement is not included. For example, the array may be caused to expand to a larger size for the duration of the feature game, or may be caused to change size in association with each play of the feature game. Such changes in array size may be randomly selected or may be selected according to a preset array size. Such expansions in the array size of the symbol position array may be accompanied by the addition of further paylines that include symbol positions that were added by way of the array expansion, thereby providing additional opportunities for winning symbol patterns to be obtained.

Also similarly, the metamorphic indicator 408c may be associated with a feature game enhancement in which the player is provided with additional free plays (or spins) of the feature game beyond those that are provided by default when the free spins feature game is initiated. For example, a free-spins feature game may initially provide a player with 10 or 15 free plays of the feature game, and such an enhancement may provide a player with an additional 5 or 10 free plays of the feature game.

The feature game enhancements that may be provided when providing the feature game may, in some instances, correspond with the feature game enhancements that are associated with any and all of the metamorphic indicators 408 that correspond with the trigger symbols 406 that are included in the base game outcome that resulted in the feature game being provided. In other implementations, such as the one depicted in FIGS. 4 through 24, the feature game enhancements that may be provided when providing the feature game may correspond with a random selection of one or more feature game enhancements that are associated with the metamorphic indicators 408 that correspond with the trigger symbols 406 that are included in the base game outcome that resulted in the feature game being provided.

For example, in the feature game that is to be provided in response to the most recent base game outcome of FIG. 16, the base game outcome included trigger symbols 406 that correspond to all three of the metamorphic indicators 408, but the processor(s) of the gaming machine have randomly selected only two of the three feature game enhancements associated with the three metamorphic indicators 408 to provide in the feature game that is to be presented-the feature game enhancements associated with the metamorphic indicators 408a and 408b.

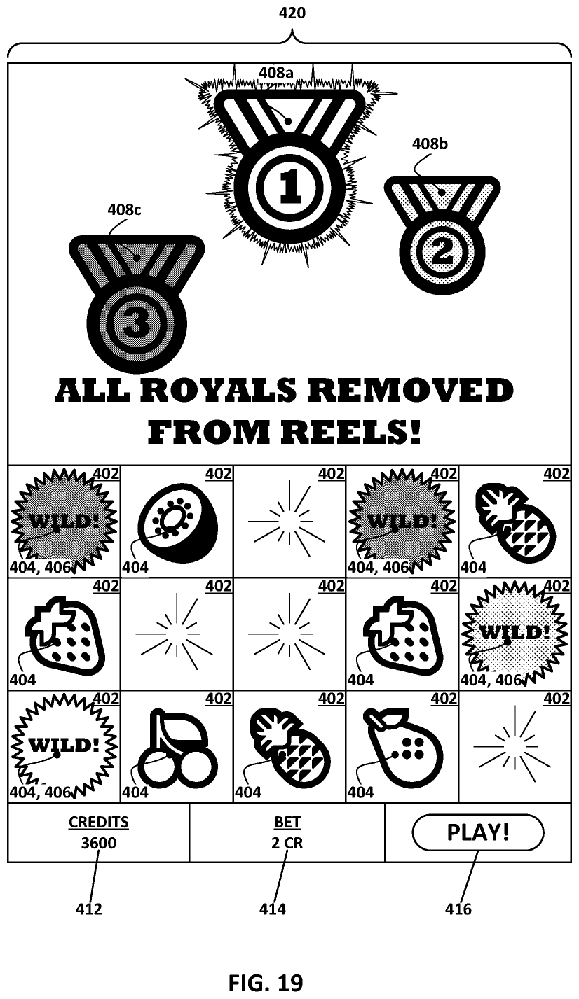

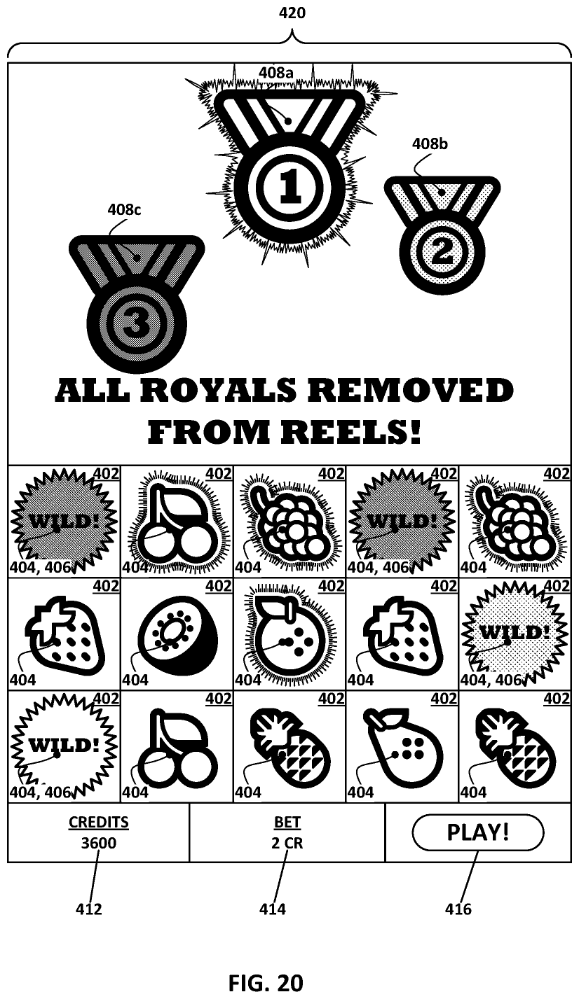

In FIG. 19, the base game GUI 400 has transitioned to the feature game GUI 420 (which may re-use many or all of the elements used in the base game GUI 400). The feature game GUI 420 may, during initial presentation, provide feedback regarding which feature game enhancements are being provided. For example, in FIG. 19, the feature game GUI 420 highlights the metamorphic indicator 408a and then provides a message indicating that “All Royals Removed From Reels!” In conjunction with this, all of the symbols 404 that are royal symbols are caused to vanish, as indicated in FIG. 19. In FIG. 20, the symbols 404 above the symbol positions 402 in which royal symbols 404 were previously displayed may be caused to move downward (or new symbols 404 displayed) so as to fill in the now-empty symbol positions 402 that previously displayed the royal symbols.

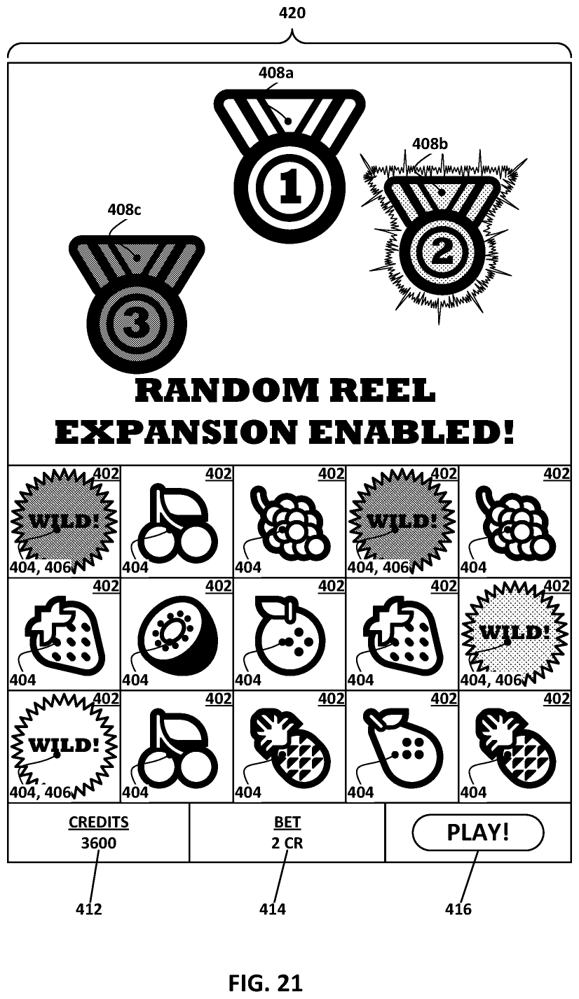

In FIG. 21, the feature game GUI 420 highlights the metamorphic indicator 408b and then provides a message indicating “Random Reel Expansion Enabled!” At this point, a user is able to initiate play of the feature game, e.g., by pressing the “Play!” button.

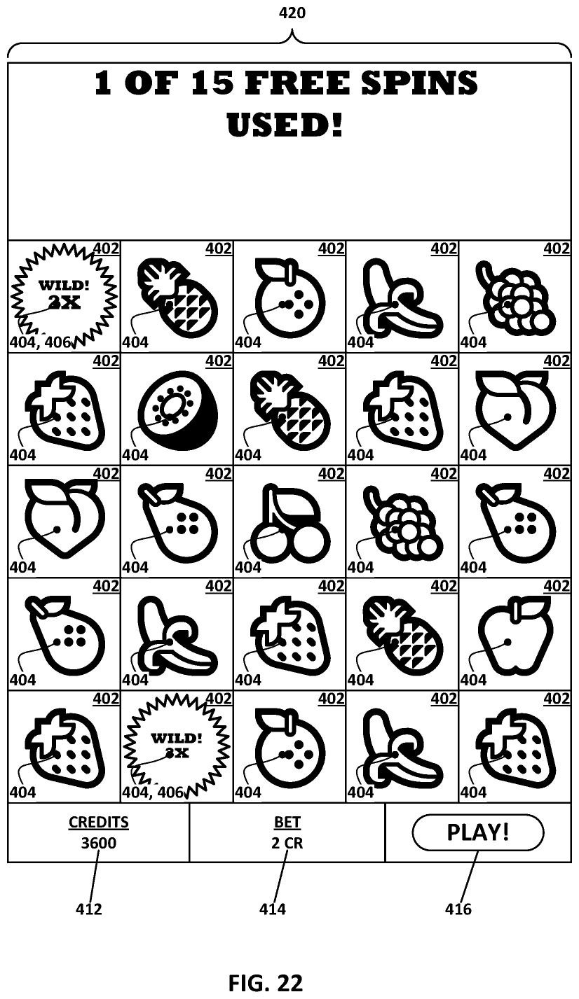

FIG. 22 depicts the feature game GUI 420 after the first feature game play has occurred. As can be seen, the array of symbol positions 402 expanded to a 5×5 array of symbol positions 402 for the first play of the feature game. The feature game outcome that is provided, as can be seen, includes symbols 404 that include fruit symbols, but no royal symbols (since all of the royal symbols have been removed). The symbols 404 also include some trigger symbols 406. However, the feature game GUI 420 may not include the metamorphic indicators 408, and the trigger symbols 406 may thus not cause any collection events to occur. However, in some implementations, a random determination may be made by the processor(s) of the gaming machine as to whether or not any of the trigger symbols 406 should be assigned a multiplier value that may then be applied to the award(s) associated with any winning pattern(s) that include such trigger symbols 406. For example, in FIG. 22, there are two trigger symbols 406, and a random determination has been made that both trigger symbols 406 are to be assigned multiplier values, e.g., a 2× and a 3× multiplier value. In other implementations, each trigger symbol 406 that is displayed may be assigned a multiplier value. In either case, there may be a maximum number of multipliers, e.g., three multipliers, that may be assigned to the trigger symbols 406 that may be displayed in any given feature game outcome. The amounts of the multipliers may be pre-set or may be randomly selected from a pool of different multiplier amounts, e.g., a 2×, a 3×, a 5×, an 8×, and a 10×multiplier. The feature game GUI 420 may also indicate the number of feature game plays remaining (or used).

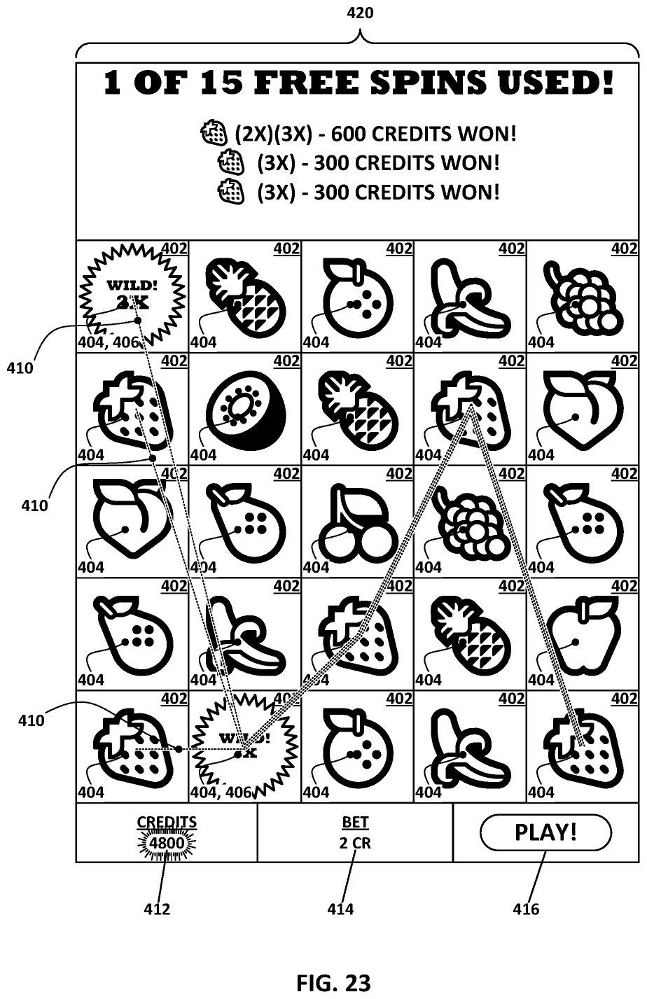

The feature game outcome of FIG. 22 includes symbols 404 that form three winning symbol patterns along paylines 410 (using the strawberry symbols and the two trigger symbols 406, which act as wild symbols), as shown in FIG. 23. As with the earlier instance in which a five-of-a-kind pattern was obtained with the strawberry symbols, the three winning patterns formed in the feature game outcome of FIG. 23 each result in awards of 100 credits being provided. However, such winning patterns also include symbols 404 that include multiplier values, and the feature game GUI 420 thus indicates the awarded credit values with multipliers applied, as shown at the top of the feature game GUI 420.

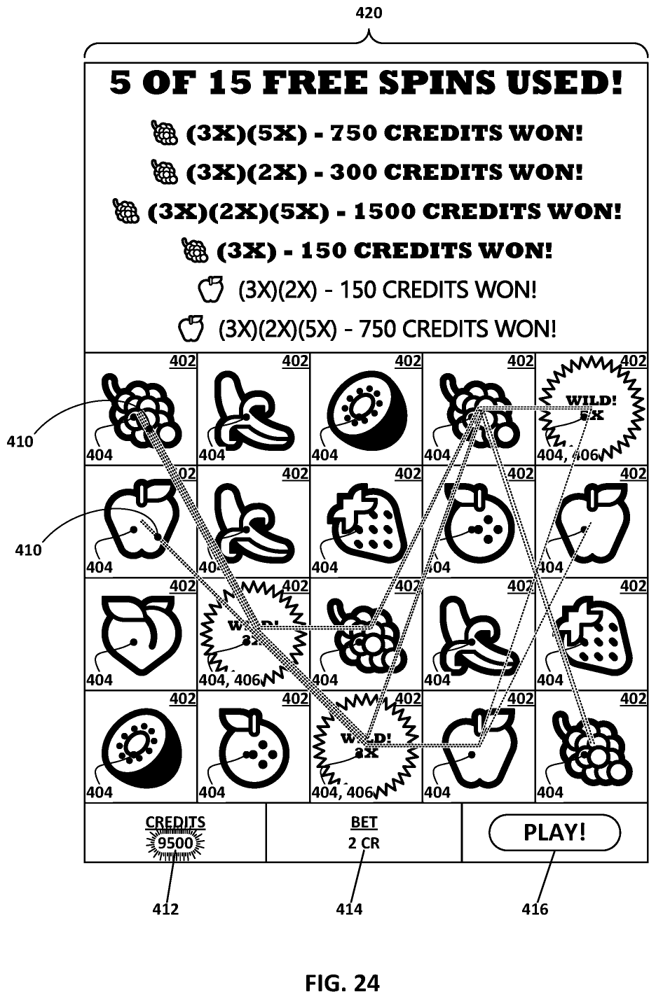

In FIG. 24, the feature game GUI 420 is shown again after several more plays of the feature game have occurred. In this particular feature game outcome, there are a total of six winning symbol patterns formed (using grape and apple symbols), each of which includes between one and three symbols 404 that include multipliers. Correspondingly, the award amounts with the winning patterns (50 credits for five-of-a-kind of grape symbols and 25 credits for five-of-a-kind of apple symbols).

Once the feature game concludes, the feature game GUI 420 may revert back to the base game GUI 400, and further play of the base game may be provided.

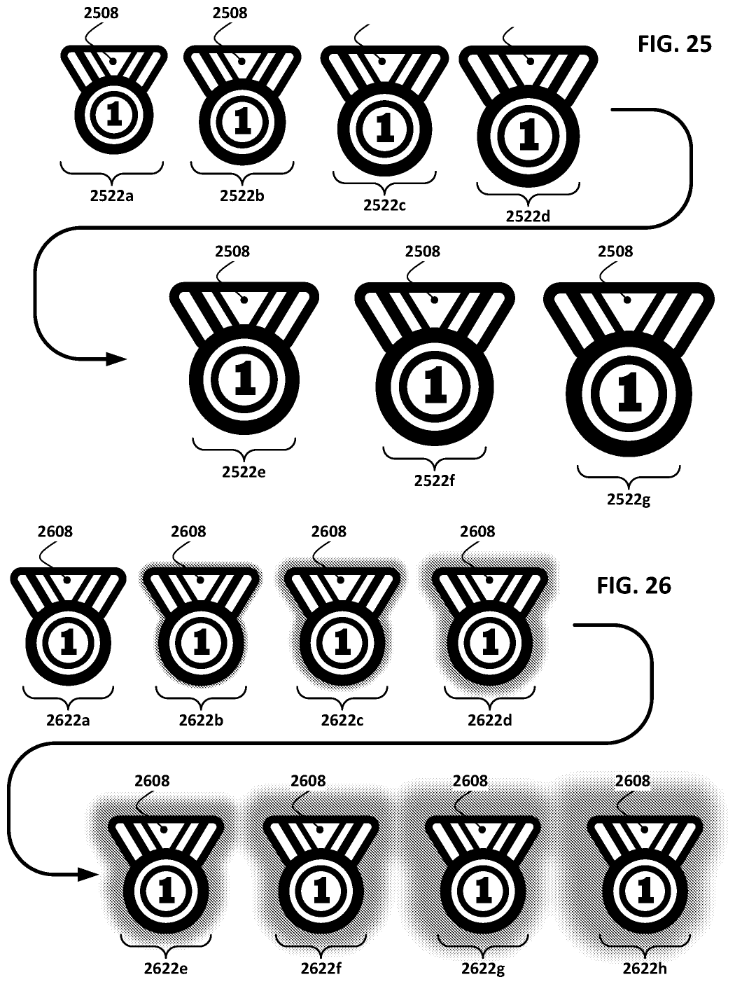

FIGS. 25 and 26 depict examples of graphical states for metamorphic indicators, although other implementations may feature other types of graphical states. In FIG. 25, multiple graphical states 2522a-2522g for a metamorphic indicator 2508 are shown. The metamorphic indicator 2508 may, for example, initially be shown in the graphical state 2522a, and may then be progressed or transitioned through each of the remaining graphical states 2522b through 2522g in turn responsive to a determination that the metamorphic indicator 2508 is to undergo a graphical state change. As can be seen, the metamorphic indicator 2508 grows progressively larger, e.g., 10% larger, compared to the size of the metamorphic indicator 2508 in the graphical state 2522a in each graphical state. It will be understood that there may be any number of graphical states, and that each graphical state may be generated at runtime, e.g., by calculating a scaling factor and applying it to a three-dimensional model or two-dimensional image of the metamorphic indicator to cause the metamorphic indicator 2508 to grow over time.

In FIG. 26, multiple graphical states 2622a-2622h for a metamorphic indicator 2608 are shown. The metamorphic indicator 2608 may, for example, initially be shown in the graphical state 2622a, and may then be progressed or transitioned through each of the remaining graphical states 2622b through 2622h in turn responsive to a determination that the metamorphic indicator 2608 is to undergo a graphical state change. As can be seen, the metamorphic indicator 2608 is provided with a halo, glow, or nimbus around it that gets progressively larger or more intense/bright with each successive graphical state 2622.

When an enhancement corresponding with a metamorphic indicator is provided, e.g., as a feature game enhancement, the graphical state of the metamorphic indicator may then be reset to the initial graphical state.

It will be further understood that the features that may be provided responsive to one or more collection events occurring, e.g., the first feature or the second feature, may, as in the above example, be a feature game (e.g., a feature requiring that the player engage in further play-different from the base game play-in order to obtain the benefit associated with the feature) and a bonus or benefit that may apply during base game play (e.g., such as the multiplier that may be applied to awards for winning patterns in the base game outcome), but may also, in other implementations, be differently configured. For example, both the first feature and the second feature may be feature games, e.g., different kinds of feature games, such as a hold-and-spin feature game and a free-spins feature game, or the same kind of feature game but with different parameters that make play experiences of the feature games different. In another example, both the first feature and the second feature may be features that provide a benefit or bonus during base game play, e.g., replacing some symbols on one or more reels with wild symbols for a predetermined number of base game plays to make it easier to obtain winning patterns in those base game plays, applying a multiplier to one or more awards obtained in a base game outcome, removing one or more symbol types from the reels for one or more base game plays, etc.

The random selection of symbols that may be performed in the base game and/or the feature game may be made in a variety of ways, and different random selection mechanisms may be employed in the base game compared to the feature game.

For example, the symbols selected for display in the symbol positions of each column may be selected in a variety of ways. In some implementations, each symbol displayed in each symbol position may be selected randomly and independently from the selection of other symbols displayed in the other symbol positions. In other implementations, the symbols displayed in each of the symbol positions of each column may be randomly selected as a block from a larger, ordered sequence of symbols. For example, each column of symbol positions may be associated with a particular ordered sequence of symbols, e.g., a reel strip, and a random selection may be made of X adjacent symbols in that ordered sequence of symbols, where X is the number of symbol positions in the associated column of symbol positions (the ordered sequences of symbols may be circular or modulo sequences such that when a selected block of symbols extends past the start or end of the sequence, the symbols at the other of the end and the start of the sequence are used to provide missing symbols). Such an approach may also be used in the feature game(s).

It will be understood that the various GUIs and game mechanics discussed herein may be implemented entirely locally, e.g., by a processor or processors of a single device, such as a smartphone, or may be provided using processors located in different devices or systems. Information regarding the selection of symbols, awards associated with special symbols, etc., may be transmitted, e.g., via a network connection (wired, wireless, or a mixture of both) to another device, e.g., a smartphone, the processor or processors of which may then implement the GUI and/or feature game mechanic using the information regarding the symbols, awards, etc. Such information may be generated and/or sent in response to receipt of a request from such another device, e.g., a request from a smartphone for the server to provide such information. Such distributed-computing implementations of the GUI provisioning techniques discussed herein is to be understood to also be within the scope of this disclosure.

It will be appreciated that in such distributed computing arrangements, the computer-executable instructions for implementing the GUI may be distributed between different memory devices located in different devices, e.g., the computer-executable instructions for selecting symbols stored on one or more memory devices of a server, while the computer-executable instructions for presenting the GUI may be stored on one or more memory devices of a client gaming device, e.g., a smartphone.

In recognition of the possibility of such distributed processing arrangements, the term “collectively,” as used herein with reference to memory devices and/or processors or various other items, should be understood to indicate that the referenced collection of items has the characteristics or provides the functionalities that are associated with that collection. For example, if a server and a client device collectively store instructions for causing A, B, and C to occur, this encompasses at least the following scenarios:
a) The server stores instructions for causing A, B, and C to occur, but the client device stores no instructions that cause A, B, and C to occur.
b) The client device stores instructions for causing A, B, and C to occur, but the server stores no instructions that cause A, B, and C to occur.
c) The server stores instructions for causing a proper subset of A, B, and C to occur, e.g., A and B but not C, and the client device stores instructions that cause a different proper subset of A, B, and C to occur, e.g., C but not A and B, where instructions for causing each of A, B, and C to occur are respectively stored on either or both the client device and the server.
d) The server stores instructions for causing a subset of A, B, and C to occur, e.g., A and B but not C, and the client device stores instructions that cause a different subset of A, B, and C to occur, e.g., B and C but not A, where instructions for causing each of A, B, and C to occur are respectively stored on either or both the client device and the server.
e) The server stores instructions for causing A and a portion of B to occur, and the client device stores instructions that cause C and the remaining portion of B to occur.

In all of the above scenarios, between the server and the client device, there are, collectively, instructions that are stored for causing A, B, and C to occur, i.e., such instructions are stored on one or both devices and it will be recognized that using the term “collectively,” e.g., the server and the client device, collectively, store instructions for causing A, B, and C to occur, encompasses all of the above scenarios as well as additional, similar scenarios.

Similarly, a collection of processors, e.g., a first set of one or more processors and a second set of one or more processors, may be caused, collectively, to, perform one or more actions, e.g., actions A, B, and C. As with the previous example, various permutations fall within the scope of such “collective” language:
a) The first set of one or more processors may be caused to perform each of A, B, and C, and the second set of one or more processors may not perform any of A, B, or C.
b) The second set of one or more processors may be caused to perform each of A, B, and C, and the first set of one or more processors may not perform any of A, B, or C.
c) The first set of one or more processors may be caused to perform a proper subset of A, B, and C, and the second set of one or more processors may be caused to perform a different proper subset of A, B, and C to be performed such that between the two sets of processors, all of A, B, and C are caused to be performed.
d) The first set of one or more processors may be caused to perform A and a portion of B, and the second set of one or more processors may be caused to perform C and the remainder of B.

It is to be understood that the phrases “for each <item> of the one or more <items>,” “each <item> of the one or more <items>,” or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite the fact that dictionary definitions of “each” frequently define the term to refer to “every one of two or more things”) and would not imply that there must be at least two of those items.

The term “between,” as used herein and when used with a range of values, is to be understood, unless otherwise indicated, as being inclusive of the start and end values of that range. For example, between 1 and 5 is to be understood to be inclusive of the numbers 1, 2, 3, 4, and 5, not just the numbers 2, 3, and 4.

The use, if any, of ordinal indicators, e.g., (a), (b), (c) . . . or the like, in this disclosure and claims is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated) unless indicated otherwise. For example, if step (ii) involves the handling of an element that is created in step (i), then step (ii) may be viewed as happening at some point after step (i). Similarly, if step (i) involves the handling of an element that is created in step (ii), the reverse is to be understood. It is also to be understood that use of the ordinal indicator “first” herein, e.g., “a first item,” should not be read as suggesting, implicitly or inherently, that there is necessarily a “second” instance, e.g., “a second item.”

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming machine comprising:
one or more displays;
one or more processors; and
one or more memory devices storing computer-executable instructions which, when executed by the one or more processors, cause the one or more processors to:
cause a base game graphical user interface (GUI) to be displayed on the one or more displays, the base game GUI including an array of symbol positions and one or more metamorphic indicators associated with a base game,
cause, for each play of the base game, a selection of symbols to be displayed in the symbol positions,
cause, for each symbol position in which the symbol displayed therein is a trigger symbol associated with one of the one or more metamorphic indicators, a corresponding collection event associated with that symbol position to occur,
cause, for each collection event, display of a collection animation involving the trigger symbol displayed in the corresponding symbol position of that collection event and the metamorphic indicator associated with the trigger symbol displayed in the corresponding symbol position of that collection event,
randomly determine, for each play of the base game in which one or more collection events occurred, whether to a) enable a first feature and not enable a second feature, b) enable the second feature and not enable the first feature, or c) not enable the first feature nor the second feature,
cause, for each play of the base game in which one or more collection events occurred in association with a determination that a) the first feature is to be enabled and the second feature is to not be enabled, a GUI to be presented in which the first feature is enabled and the second feature is not enabled,
cause, for each play of the base game in which one or more collection events occurred in association with a determination that b) the second feature is to be enabled and the first feature is to not be enabled, the second feature to be enabled without the first feature being enabled, and
cause, for each play of the base game in which one or more collection events occurred in association with a determination that c) neither the first feature nor the second feature is to be enabled, the first feature and the second feature to not be enabled.

2. The electronic gaming machine of claim 1, wherein the trigger symbols are wild symbols that are treated as one or more other symbols when determining winning symbol patterns.

3. The electronic gaming machine of claim 2, wherein:
each metamorphic indicator is associated with a corresponding feature game enhancement, and
the one or more memory devices store further computer-executable instructions which, when executed by the one or more processors, cause the one or more processors to, for each play of the base game that results in the first feature being enabled, cause a GUI for the feature game to be provided that includes the feature game enhancement(s) in a set of one or more feature game enhancements selected from the feature game enhancement(s) associated with the metamorphic indicator(s) that were involved in any collection animation resulting from that play of the base game.

4. The electronic gaming machine of claim 3, wherein the feature game is a free-spins game in which a predetermined number of feature game plays is provided for a user and each feature game play in the free-spins game requires no wager.

5. The electronic gaming machine of claim 4, wherein:
the feature game includes an array of symbol positions, and
the feature game enhancements include at least one of a first feature game enhancement in which the array of symbol positions includes additional symbol positions that are not present when the first feature game enhancement is not included, a second feature game enhancement in which symbol sets from which symbols are selected for display in the symbol positions responsive to each play of the feature game have a reduced number of symbols as compared with the symbol sets when the second feature game enhancement is not included, and a third feature game enhancement in which one or more additional feature game plays is provided for the user in addition to the predetermined number of feature game plays.

6. The electronic gaming machine of claim 2, wherein the second feature is a multiplier feature that, when enabled, causes one or more of the displayed trigger symbols to display a corresponding multiplier value and causes a value associated with any winning pattern of displayed symbols that includes at least one trigger symbol that displays a corresponding multiplier value to be multiplied, before being added to a credit meter presented on the one or more displays, by the displayed multiplier value for each trigger symbol in the winning pattern that displays a corresponding multiplier value.

7. The electronic gaming machine of claim 1, wherein the one or more memory devices store further computer-executable instructions which, when executed by the one or more processors, cause the one or more processors to:
determine, for each collection event, whether the metamorphic indicator associated with the trigger symbol displayed in the corresponding symbol position of that collection event, is to undergo a graphical state change, and
cause, for each instance in which a determination is made that a metamorphic indicator is to undergo a graphical state change, that metamorphic indicator to undergo a graphical state change.

8. One or more non-transitory, computer-readable media storing computer-executable instructions which, when executed by one or more processors, cause the one or more processors to:
cause a base game graphical user interface (GUI) to be displayed on one or more displays, the base game GUI including an array of symbol positions and one or more metamorphic indicators associated with a base game,
cause, for each play of the base game, a selection of symbols to be displayed in the symbol positions,
cause, for each symbol position in which the symbol displayed therein is a trigger symbol associated with one of the one or more metamorphic indicators, a corresponding collection event associated with that symbol position to occur,
cause, for each collection event, display of a collection animation involving the trigger symbol displayed in the corresponding symbol position of that collection event and the metamorphic indicator associated with the trigger symbol displayed in the corresponding symbol position of that collection event,
randomly determine, for each play of the base game in which one or more collection events occurred, whether to a) enable a first feature and not enable a second feature, b) enable the second feature and not enable the first feature, or c) not enable the first feature nor the second feature,
cause, for each play of the base game in which one or more collection events occurred in association with a determination that a) the first feature is to be enabled and the second feature is to not be enabled, a GUI to be presented in which the first feature is enabled and the second feature is not enabled,
cause, for each play of the base game in which one or more collection events occurred in association with a determination that b) the second feature is to be enabled and the first feature is to not be enabled, the second feature to be enabled without the first feature being enabled, and
cause, for each play of the base game in which one or more collection events occurred in association with a determination that c) neither the first feature nor the second feature is to be enabled, the first feature and the second feature to not be enabled.

9. The one or more non-transitory, computer-readable media of claim 8, wherein the trigger symbols are wild symbols that are treated as one or more other symbols when determining winning symbol patterns.

10. The one or more non-transitory, computer-readable media of claim 9, wherein:
each metamorphic indicator is associated with a corresponding feature game enhancement, and
the one or more non-transitory, computer-readable media store further computer-executable instructions which, when executed by the one or more processors, cause the one or more processors to, for each play of the base game that results in the first feature being enabled, cause a GUI for the feature game to be provided that includes the feature game enhancement(s) in a set of one or more feature game enhancements selected from the feature game enhancement(s) associated with the metamorphic indicator(s) that were involved in any collection animation resulting from that play of the base game.

11. The one or more non-transitory, computer-readable media of claim 10, wherein the feature game is a free-spins game in which a predetermined number of feature game plays is provided for a user and each feature game play in the free-spins game requires no wager.

12. The one or more non-transitory, computer-readable media of claim 11, wherein:
the feature game includes an array of symbol positions, and
the feature game enhancements include at least one of a first feature game enhancement in which the array of symbol positions includes additional symbol positions that are not present when the first feature game enhancement is not included, a second feature game enhancement in which symbol sets from which symbols are selected for display in the symbol positions responsive to each play of the feature game have a reduced number of symbols as compared with the symbol sets when the second feature game enhancement is not included, and a third feature game enhancement in which one or more additional feature game plays is provided for the user in addition to the predetermined number of feature game plays.

13. The one or more non-transitory, computer-readable media of claim 9, wherein the second feature is a multiplier feature that, when enabled, causes one or more of the displayed trigger symbols to display a corresponding multiplier value and causes a value associated with any winning pattern of displayed symbols that includes at least one trigger symbol that displays a corresponding multiplier value to be multiplied, before being added to a credit meter presented on the one or more displays, by the displayed multiplier value for each trigger symbol in the winning pattern that displays a corresponding multiplier value.

14. The one or more non-transitory, computer-readable media of claim 8, wherein the one or more non-transitory, computer-readable media store further computer-executable instructions which, when executed by the one or more processors, cause the one or more processors to:
determine, for each collection event, whether the metamorphic indicator associated with the trigger symbol displayed in the corresponding symbol position of that collection event, is to undergo a graphical state change, and
cause, for each instance in which a determination is made that a metamorphic indicator is to undergo a graphical state change, that metamorphic indicator to undergo a graphical state change.

15. A method comprising:
causing, by one or more processors of a gaming machine, a base game graphical user interface (GUI) to be displayed on one or more displays, the base game GUI including an array of symbol positions and one or more metamorphic indicators associated with a base game;
causing, by the one or more processors of a gaming machine and for each play of the base game, a selection of symbols to be displayed in the symbol positions;
causing, by the one or more processors of a gaming machine and for each symbol position in which the symbol displayed therein is a trigger symbol associated with one of the one or more metamorphic indicators, a corresponding collection event associated with that symbol position to occur;
causing, by the one or more processors of a gaming machine and for each collection event, display of a collection animation involving the trigger symbol displayed in the corresponding symbol position of that collection event and the metamorphic indicator associated with the trigger symbol displayed in the corresponding symbol position of that collection event;
randomly determining, by the one or more processors and for a plurality of plays of the base game in which one or more collection events occurred, that a first feature is to be enabled and a second feature is to be not enabled in response to at least one play of the base game, that the first feature is to be not enabled and the second feature is to be enabled in response to at least one other play of the base game, and that neither the first feature nor the second feature is to be enabled in response to at least one more play of the base game;
causing, by the one or more processors of a gaming machine and for each play of the base game in which one or more collection events occurred in association with a determination that a) the first feature is to be enabled and the second feature is to not be enabled, a GUI to be presented in which the first feature is enabled and the second feature is not enabled;
causing, by the one or more processors of a gaming machine and for each play of the base game in which one or more collection events occurred in association with a determination that b) the second feature is to be enabled and the first feature is to not be enabled, the second feature to be enabled without the first feature being enabled; and
causing, by the one or more processors of a gaming machine and for each play of the base game in which one or more collection events occurred in association with a determination that c) neither the first feature nor the second feature is to be enabled, the first feature and the second feature to not be enabled.

16. The method of claim 15, wherein the trigger symbols are wild symbols that are treated as one or more other symbols when determining winning symbol patterns.

17. The method of claim 16, wherein:
each metamorphic indicator is associated with a corresponding feature game enhancement, and
the method further comprises causing the one or more processors to, for each play of the base game that results in the first feature being enabled, cause a GUI for the feature game to be provided that includes the feature game enhancement(s) in a set of one or more feature game enhancements selected from the feature game enhancement(s) associated with the metamorphic indicator(s) that were involved in any collection animation resulting from that play of the base game.

18. The method of claim 17, wherein the feature game is a free-spins game in which a predetermined number of feature game plays is provided for a user and each feature game play in the free-spins game requires no wager.

19. The method of claim 18, wherein:
the feature game includes an array of symbol positions, and
the feature game enhancements include at least one of a first feature game enhancement in which the array of symbol positions includes additional symbol positions that are not present when the first feature game enhancement is not included, a second feature game enhancement in which symbol sets from which symbols are selected for display in the symbol positions responsive to each play of the feature game have a reduced number of symbols as compared with the symbol sets when the second feature game enhancement is not included, and a third feature game enhancement in which one or more additional feature game plays is provided for the user in addition to the predetermined number of feature game plays.

20. The method of claim 16, wherein the second feature is a multiplier feature with a multiplier that, when enabled, causes one or more of the displayed trigger symbols to display a corresponding multiplier value and causes a value associated with any winning pattern of displayed symbols that includes at least one trigger symbol that displays a corresponding multiplier value to be multiplied, before being added to a credit meter presented on the one or more displays, by the displayed multiplier value for each trigger symbol in the winning pattern that displays a corresponding multiplier value.
